(19) United States
(12) Patent Application Publication
(10) Pub. No.: US 2005/0198331 A1
(43) Pub. Date: Sep. 8, 2005

(54) Seamless system and recording medium, and computer system process continuing method

(76) Inventors: Masaaki Okajima, Tokyo (JP); Shigeru Matsumoto, Tokyo (JP); Kimio Saba, Tokyo (JP); Asahiko Yamada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/024,617

(22) Filed: Dec. 30, 2004

Related U.S. Application Data
(63) Continuation of application No. PCT/JP03/08054, filed on Jun. 25, 2003.

(30) Foreign Application Priority Data
Jul. 1, 2002 (JP) 2002-192670

(51) Int. Cl. G06F 15/16

(52) U.S. Cl. 709/229; 709/203

(57) ABSTRACT

A seamless system according to the present invention manages data obtained by associating user identification data accepted from a device with processing identification data indicating a process requested to be executed from the device, registers in the data restart achievement data to be used to achieve restarting of the process indicating processing identification data, acquires the processing identification data and restart achievement data corresponding to the user identification data based on the data when a restart request and the user identification have been accepted, and provides to an originating device making a restart request an execution result of the process indicated by the processing identification data obtained based on the restart achievement data.

### CROSS-REFERENCE TO RELATED APPLICATIONS

This is a Continuation Application of PCT Application No. PCT/JP03/08054, filed Jun. 25, 2003, which was published under PCT Article 21(2) in Japanese.

This application is based upon and claims the benefit of priority from prior Japanese Patent Application No. 2002-192670, filed Jul. 1, 2002, the entire contents of which are incorporated herein by reference.

### BACKGROUND OF THE INVENTION

1. Field of the Invention

The present invention relates to a system to be accessed from a user's operating device via a network, recording medium, and a computer system process continuing method.

2. Description of the Related Art

One general computer utilization mode includes each user possessing and utilizing a computer. In addition, another general computer utilization mode includes a plurality of users utilizing a shared computer in joint.

In the case where a user starts utilization of a computer which is not powered ON, the user turns ON the power. When ID management is made, the user inputs one's own user ID and logs on. Then, the computer enters an initial state of starting utilization.

Thereafter, the user executes a work by utilizing the computer in accordance with one's own intention. When the work is terminated, the user turns OFF the computer after a termination process has been carried out.

In such a computer utilization mode, in the case where the user wants to turn OFF the computer power after interrupting a work, it is necessary to terminate the work or cancel the work in progress to turn off the power supply.

On the other hand, there exists a single computer which supports an interrupting function for interrupting a work.

A user utilizing such a computer which supports the interrupting function turns OFF the power supply after executing an interrupting process, and further, carries out a restart process after turning ON the power supply again. Then, the user can continue the work which has been done before the power is turned OFF even after the computer power has been turned OFF.

Even if this interrupting function is used, however, the work interrupted in one computer is not restarted by another computer.

### BRIEF SUMMARY OF THE INVENTION

The present invention relates to a seamless system and program capable of continuing a work between a plurality of terminals connected to a network, and a computer system process continuing method.

A seamless system according to the first invention comprises:

a managing unit which manages utilization state data obtained by associating user identification data accepted from a device with processing identification data indicating a process requested to be executed from the device;

a storage unit which registers in the utilization state data, restart achievement data to be used to achieve restarting of the process indicated by the processing identification data; and

a restarting unit which, when a restart request and the user identification data have been accepted, acquires the processing identification data and the restart achievement data corresponding to the user identification data based on the utilization state data, and provides to an originating device making the restart request an execution result of the process indicated by the processing identification data obtained based on the restart achievement data.

A seamless system according to the second invention comprises:

a managing unit which manages utilization state data obtained by associating user identification data accepted from a device with processing identification data indicating a process requested to be executed from the device; and

a restarting unit which, when a restart request and the user identification data have been accepted, acquires the processing identification data corresponding to the user identification data based on the utilization state data, and provides to an originating device making the restart request an execution result of the process indicated by the processing identification data.

A seamless system according to the third invention comprises:

a managing unit which manages utilization state data obtained by associating user identification data accepted from a device with processing identification data indicating a process requested to be executed from the device;

a storage unit which, when an interrupt event has occurred in the device, registers in the utilization state data, state data indicating that the process indicated by the processing identification data has been interrupted; and

a restarting unit which, when a restart request and the user identification data have been accepted, acquires processing identification data for restart indicating interruption by the state data in association with the user identification data from among the utilization state data, and provides to an originating device making the restart request an execution result of the process indicated by the processing identification data for restart.

A seamless system according to the fourth invention comprises:

a managing unit which registers user identification data accepted from a device in utilization state data;

a storage unit which registers restart achievement data to be used to achieve restarting of a predetermined process in the utilization state data in association with the user identification data; and

a restarting unit which, when a restart request and the user identification data have been accepted, acquires the restart achievement data in association with the user identification data based on the utilization state data, and provides to an originating device making the restart request an execution result of the process obtained based on the restart achievement data.

A seamless system according to the fifth invention comprises:

a managing unit which manages utilization state data obtained by associating user identification data accepted from a device with processing identification data indicating a process requested to be executed from the device; and

a rewriting unit which, when address information on another process is included in contents provided to the device, rewrites the address information into address information including link information on one's own system based on the address information, wherein

the managing unit stores received information as the utilization state data when receiving the processing identification data based on the address information rewritten by the rewriting unit, and restarts a process corresponding to the user identification data based on the utilization state data when accepting the process restart request from the device and the user identification data.

A seamless system according to the sixth invention comprises:

a managing unit which manages utilization state data obtained by associating user identification data accepted from a device, processing identification data indicating a process requested to be executed from the device, and state information on the process; and

an adding unit which embeds a command for notifying the state information on the device to one's own system in the contents provided to the device, wherein

when the state information has been accepted from the device, the managing unit registers the received information in the utilization state data, and when a restart request and the user identification data have been accepted, the managing unit restarts a process corresponding the user identification data based on the utilization state data.

A seamless system according to the seventh invention comprises:

a managing unit which manages utilization state data obtained by associating user identification data accepted from a device, processing identification data indicating a process requested to be executed from the device, and state information on the process;

a rewriting unit which, when address information on another process is included in contents provided to the device, rewrites the address information into address information including link information on one's own system based on the address information; and

an adding unit which embeds a command for notifying the state information on the device to one's own system in the contents provided to the device, wherein

the managing unit stores received information as the utilization data when receiving the processing identification data based on the address information rewritten by the rewriting unit, registers the state information in the utilization state data when the state information has been accepted from the device, carries out restarting of the processing identification data corresponding to the user identification data and a process from the device based on the utilization state data when accepting the process restart request from the device and the user identification data, and carries out restarting of a process corresponding to the user identification data based on the utilization state data.

A computer system process continuing method is carried out by each of the above-described seamless systems.

Constituent elements which such each seamless system comprises may be carried out by a program read in a computer. By this program or a recording medium having the program recorded therein, the computer can be caused to function as the above-described seamless system.

### BRIEF DESCRIPTION OF THE SEVERAL VIEWS OF THE DRAWING

FIG. 1 is a block diagram depicting an example of a configuration of a seamless system according to the first embodiment.

FIG. 2 is a view showing an example of the user profile data according to the first embodiment.

FIG. 3 is a flow chart showing an example of processing of the seamless system according to the first embodiment.

FIG. 4 is a flow chart showing an example of process in the case where service starting, interruption, and restarting have been requested according to the first embodiment.

FIG. 5 is a sequence chart showing an example of operation from connection of the terminal to starting service according to the first embodiment.

FIG. 6 is a sequence chart showing an example of operation in the case of interrupting the service utilized by the user according to the first embodiment.

FIG. 7 is a sequence chart showing an example of operation in the case where the user requests restarting of the service from another terminal according to the first embodiment.

FIG. 8 is a view showing an example of a changing state of user profile data according to the first embodiment.

FIG. 9 is a block diagram depicting a first service continuation example of the seamless system according to the first embodiment.

FIG. 10 is a block diagram depicting a second service continuation example of the seamless system according to the first embodiment.

FIG. 11 is a block diagram depicting a second service continuation example of the seamless system according to the third embodiment.

FIG. 12 is a block diagram depicting a first session maintaining example between a seamless system and a service server according to the first embodiment.

FIG. 13 is a block diagram depicting a second session maintaining example between a seamless system and a service server according to the first embodiment.

FIG. 14 is a block diagram depicting a third session maintaining example between a seamless system and a service server according to the first embodiment.

FIG. 15 is a block diagram depicting an example in which the seamless system according to the first embodiment has been applied to a ubiquitous system.

FIG. 16 is a block diagram depicting an example of a configuration of a seamless system according to the second embodiment.

FIG. 17 is a sequence chart showing an example of operation from connection of the terminal to starting of service according to the third embodiment.

FIG. 18 is a sequence chart showing an example of operation in the case where a user interrupts the service being utilized according to the third embodiment.

FIG. 19 is a sequence chart showing an example of operation in the case where a user requests restarting of the service by utilizing another terminal according to the third embodiment.

FIG. 20 is a view showing an example of a changing state of user profile data according to the third embodiment.

FIG. 21 is a view showing an example of user profile data according to the fourth embodiment.

FIG. 22 is a sequence chart showing an example of operation from connection of the terminal to service interruption according to the fourth embodiment.

FIG. 23 is a sequence chart showing an example of operation in the case where a user requests restarting of a service by utilizing another terminal after service interruption according to the fourth embodiment.

FIG. 24 is a block diagram depicting an example of a configuration of the seamless system according to the fifth embodiment.

FIG. 25 is a view showing a specific example of user management data.

FIG. 26 is a view showing a specific example of the state management data.

FIG. 27 is a view showing an example of a request included the state management data.

FIG. 28 is a view showing an example of execution data included the state management data.

FIG. 29 is a view showing an example of a work.

FIG. 30 is a block diagram depicting a first conversion example of execution data provided from a service to a Web browser according to the fifth embodiment.

FIG. 31 is a block diagram depicting a second conversion example of execution data provided from a service to a Web browser according to the fifth embodiment.

FIG. 32 is a block diagram depicting a third conversion example of execution data provided from a service to a Web browser according to the fifth embodiment.

FIG. 33 is a block diagram depicting a fourth conversion example of execution data provided from a service to a Web browser according to the fifth embodiment.

FIG. 34 is a block diagram depicting a fifth conversion example of execution data provided from a service to a Web browser according to the fifth embodiment.

FIG. 35 is a sequence chart showing a first stage operation from a request for a user to start utilization of service to display of contents in the fifth embodiment.

FIG. 36 is a sequence chart showing a second stage operation from a request for a user to start utilization of service to display of contents in the fifth embodiment.

FIG. 37 is a sequence chart showing a first stage operation in the case where a service has been called after contents has been displayed in the fifth embodiment.

FIG. 38 is a sequence chart showing a second stage operation in the case where a service has been called after contents has been displayed in the fifth embodiment.

FIG. 39 is a sequence chart showing an operation in the case where a service is interrupted in the fifth embodiment.

FIG. 40 is a sequence chart showing a first stage operation in the case where utilization of service interrupted in the fifth embodiment is started from another terminal.

FIG. 41 is a sequence chart showing a second stage operation in the case where utilization of service interrupted in the fifth embodiment is started from another terminal.

FIG. 42 is a sequence chart showing a first stage operation in the case where utilization of service interrupted in the fifth embodiment is started from another terminal.

FIG. 43 is a block diagram depicting an example of a configuration of a seamless system according to the sixth embodiment.

FIG. 44 is a block diagram depicting a first modified example of execution data provided from a service to a Web browser in the sixth embodiment.

FIG. 45 is a block diagram depicting a second modified example of execution data provided from a service to a Web browser in the sixth embodiment.

FIG. 46 is a sequence chart showing a first stage operation from a user requesting service utilization start to display of contents in the sixth embodiment.

FIG. 47 is a sequence chart showing a second stage operation from a user requesting service utilization start to display of contents in the sixth embodiment.

FIG. 48 is a sequence chart showing a first stage operation in the case where a service is continuously called after contents have been displayed in the sixth embodiment.

FIG. 49 is a sequence chart showing a second stage operation in the case where a service is continuously called after contents have been displayed in the sixth embodiment.

FIG. 50 is a sequence chart showing an operation in the case where a work is interrupted.

FIG. 51 is a sequence chart showing a first stage operation for restarting utilization of the service interrupted from another terminal in the sixth embodiment.

FIG. 52 is a sequence chart showing a second stage operation for restarting utilization of the service interrupted from another terminal in the sixth embodiment.

FIG. 53 is a block diagram depicting an example of a configuration of a seamless system according to the seventh embodiment.

### DETAILED DESCRIPTION OF THE INVENTION

Hereinafter, embodiments of the present invention will be described with reference to the accompanying drawings. In the following description, like constituent elements are designated by like reference numerals. A duplicate description is omitted here.

(First Embodiment)

A seamless system according to this embodiment is connected to a network, and provides an environment for achieving a seamless work between a plurality of terminals.

In the present embodiment, the seamless work of a plurality services is carried out between a plurality of terminals.

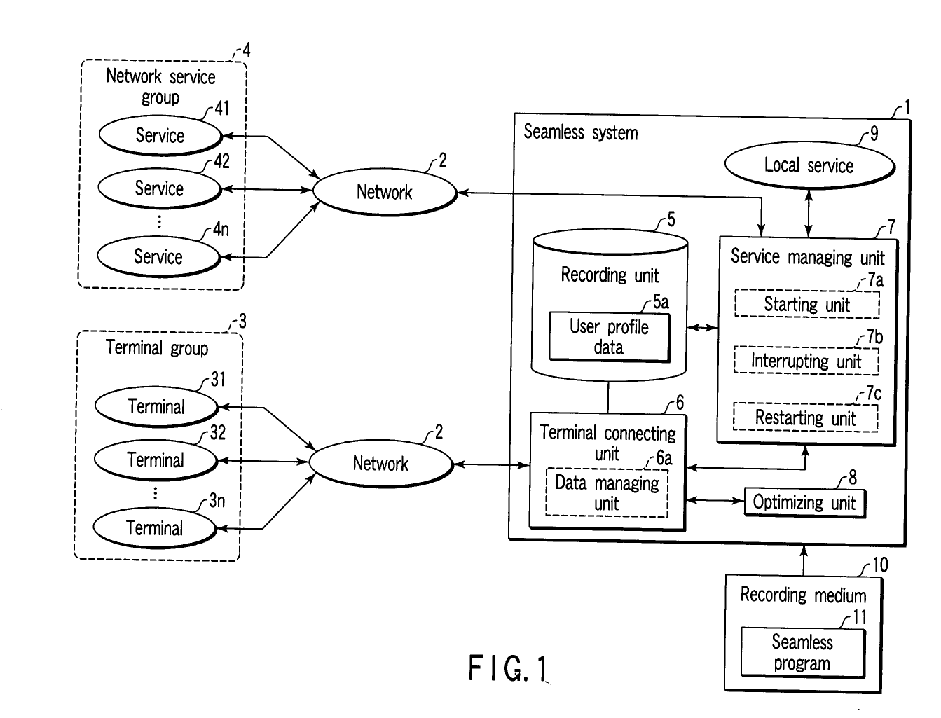

FIG. 1 is a block diagram depicting an example of a configuration of a seamless system according to this embodiment.

A seamless system 1 is connected to be communicable with terminals 31 to 3n of a terminal group 3 via a network 2 such as the Internet, for example. The seamless system 1 is also connected to a variety of services 41 to 4n of a network service group 4 via the network 2. The network 2 may be another communication network such as a LAN or an Intra-net instead of the Internet.

The seamless system 1 comprises a recording unit 5, a terminal connecting unit 6, a service managing unit 7, and an optimizing unit 8.

In addition, the seamless system 1 provides a local service 9 based on a function similar to those of the variety of services 41 to 4n of the network service group 4. The network 2 is not interposed between the seamless system 1 and the local service 9. The existence of the local service 9 is not mandatory, and all local services may be configured by network services, and to the contrary all local services may be configured by local services.

The seamless system 1 reads and executes a seamless program 11 recorded in a recording medium 10, thereby achieving a function as the terminal connecting unit 6, the service managing unit 7, and the optimizing unit 8.

The seamless program 11 may operate on a single server computer, for example, or may operate while the seamless program is linked with another seamless program in a state in which they are distributed on a plurality of computers.

The services 41 to 4n and 9 are provided to a user by executing processing by an application, a processing process, an object, a program or the like.

For example, the services 41 to 4n and 9 include a contents distributing service, an application distributing service, s streaming service, an information search service, a document editing service, and various business support services.

User profile data 5a having a role as utilization state data is recorded in the recording unit 5.

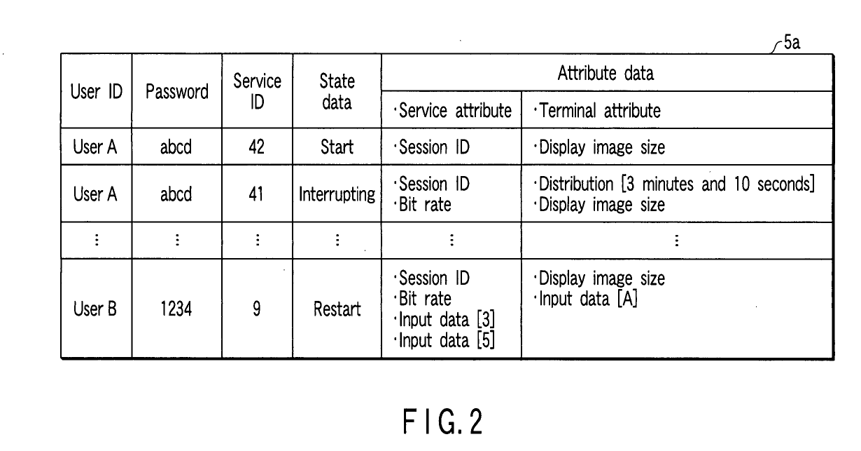

FIG. 2 shows an example of the user profile data 5a. In this example, the user profile data 5a has items “user ID”, “password”, “service ID”, “state data”, and “attribute data”. In the user profile data 5a of FIG. 2, the item “attribute data” is composed of two items “service attribute” and “terminal attribute”. Values of items managed by the user profile data 5a are associated with each other in units of lines.

The user ID is provided as user identification data of a user utilizing any of the services 41 to 4n and 9.

The password is utilized for user ID and user authentication processing.

The service ID (processing identification data) is provided as data for identifying a service utilized by a user.

The state data indicates the user's service utilization state. The state data has values of “start”, “interruption”, “reproduction” and the like, for example.

The attribute data is provided as data shared between a service and a terminal. For example, the attribute data is transmitted and received as cookie information between a service and a terminal.

The service attribute is provided as attribute data retained at the service side. Specific examples of the service attribute include a session ID, a bit rate, and data inputted by the user and provided to the service side.

The terminal attribute is provided as attribute data retained at the terminal side. Specific examples of the terminal attribute include a display image size, a distribution completion time, and data inputted by the user and utilized at the terminal side.

The above state data and attribute data are utilized to achieve service restart. In the present embodiment, although the state data and attribute data are utilized, the utilization of these items of data is not mandatory. For example, only the state data or only the attribute data may be utilized.

The terminal connecting unit 6 comprises a data managing unit 6a.

The terminal connecting unit 6 uses any of the terminals 31 to 3n; identifies a user having requested a connection based on a user ID and a password; and carried out connection management for starting, canceling, restarting, and terminating a service. The terminal connecting unit 6 may carry out user identification in accordance with another technique. For example, there may be used: a method using an electronic certificate embedded in an IC card or the like; a method using a biochemical authentication technique such as finger print authentication; and a method using a combination of several methods.

The data managing unit 6a registers: a user ID of an accepted user; accepted service ID; state data indicating a service utilization state by this user; and attribute data shared between a user operated terminal and the service.

The optimizing unit 8 selects a specification in a terminal in connection from among input and display specifications for the variety of terminals 31 to 3n, such as a display mode of contents provided by the service. Then, the optimizing unit 8 converts the data provided to the terminal in connection into the selected specification. In this manner, the data corresponding to each of the terminals 31 to 3n is optimized.

Further, the optimizing unit 8 may convert the data accepted from the terminal in connection into a data format of the service of a service providing source.

A variety of techniques can be utilized as means for carrying out the optimizing unit 8. For example, in the case where contents provided from one service are data described in HTML (Hypertext Markup Language) or XML (Extensible Markup Language), translator software called XSLT can be used as the optimizing unit 8. In this manner, an HTML or XML tag can be converted into another character string. For example, even if the contents before converted employs a data format presuming utilization on a personal computer, the contents can be converted into a format which can be interpreted by browser software incorporated in equipment other than a personal computer such as a cellular phone or a television.

In addition, trans-coding middleware or the like can be utilized for the optimizing unit 8.

The service managing unit 7 comprises a starting unit 7a, an interrupting unit 7b, and a restarting unit 7c.

The starting unit 7a of the service managing unit 7 specifies processing for carrying out the user requested service from among processing functions for achieving the services 41 to 4n on the network 2 or from processing functions for achieving the local service 9.

In order to specify the processing functions for achieving the services 41 to 4n and 9, for example, there is used a method for handling some character strings included in the processing request data provided from a terminal to the seamless system 1 as a URL (Universal Resource Locator) for use in HTTP communication of the Internet, and specifying a processing function on the network 2 by this URL.

In addition, the starting unit 7a executes a specified processing function, and acquires execution data obtained by executing the specified processing function such as the contents provided to the user by the contents distributing service, for example.

Then, the starting unit 7a executes a control for providing to a terminal operated by the user the execution data obtained until an interrupting request has been accepted from the terminal, from among the acquired execution data.

When the interrupting unit 7b has accepted an interrupting request from a terminal, the interrupting unit 7b registers the state data indicating interruption and the user ID in the user profile data 5a in association with each other, and registers the attribute data and user ID in the user profile data 5a in association with each other. For example, time data on stream contents distribution completion, data inputted by the user until interruption has been made, and the like are registered as attribute data in the user profile data 5a.

When the restarting unit 7c has accepted the user ID and a restarting request, the restarting unit 7c acquires the service ID and state data associated with the accepted user ID based on the user profile data 5a.

Further, the restarting unit 7a selects a service ID whose state data indicates interruption from among the acquired service IDs; acquires execution data after restarting the service indicated by the selected service ID; and provides the acquired execution data to an originating terminal requesting restarting (corresponding to a restarting device for restarting a work).

For example, the restarting unit 7c executes processing based on the attribute data indicating an execution stage of a processing function before interrupted; obtains execution data restored up to the stage before interrupted; and acquires execution data after restarted.

For example, the restarting unit 7c includes and stores the execution data immediately before interrupted in the user profile data 5a, whereby the stored execution data may be provided to an originating terminal of the restarting request.

The above-described network service group 4 and local service 9 of FIG. 1 may not be mandatory constituent elements and either of them may be utilized in the seamless system 1.

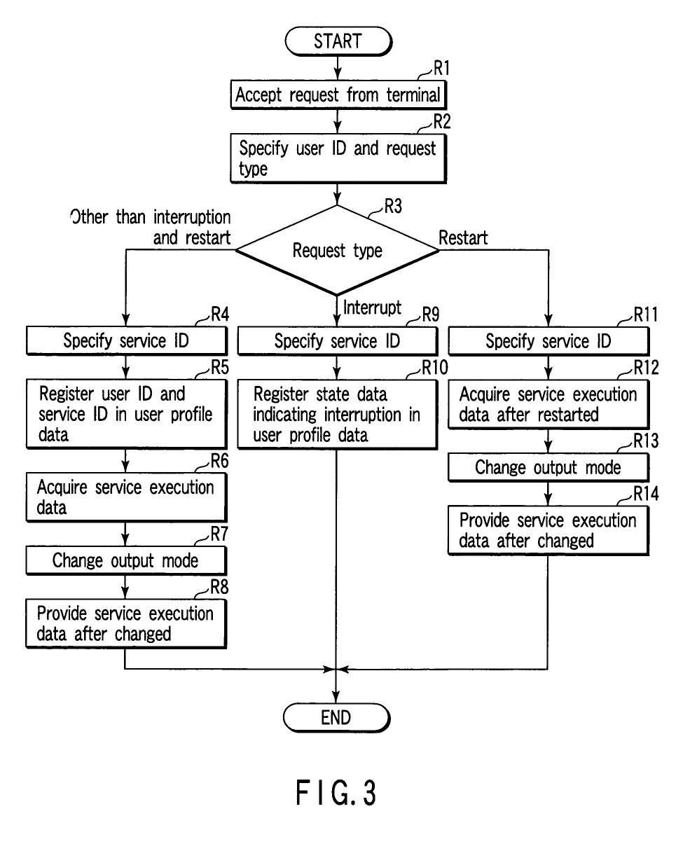

FIG. 3 is a flow chart showing an example of processing of the seamless system 1 according to the present embodiment.

In step R1, the terminal connecting unit 6 accepts a request from a terminal.

In step R2, the terminal connecting unit 6 specifies the user ID and request type based on the accepted request.

In step R3, the terminal connecting unit 6 switches the subsequent contents of processing according to request type.

In the case of a process other than interruption and restarting, i.e., in the case where the request type is “start”, the terminal connecting unit 6 specifies a service ID in step R4.

In step R5, the terminal connecting unit 6 registers the user ID and service ID in the user profile data 5a.

In step R6, the starting unit 7a acquires execution data on the service which corresponds to the service ID.

In step R7, the terminal connecting unit 6 converts the execution data acquired by the starting unit 7a into an output mode of a terminal by utilizing the optimizing unit 8.

In step R8, the terminal connecting unit 6 provides the execution data after converted to a terminal.

In the case where the request type is “interrupt”, the interrupting unit 7b specifies the service ID in step R9.

In step R10, the interrupting unit 7b registers the state data indicating interruption of the service which corresponds to the service ID in the user profile data 5a.

In the case where the request type is “restart”, in step R11, the restarting unit 7c specifies the service ID associated with the user ID, the state data of which indicates interruption, based on the user profile data 5a.

In step R12, the restarting unit 7c acquires the execution data of the service of the specified service ID, and acquires the execution data on the service after restarted, based on the attribute data.

In step R13, the terminal connecting unit 6 converts the execution data on the service after restarted, the service being acquired by the restarting unit 7c, into an output mode of an originating terminal of the restarting request by utilizing the optimizing unit 8.

In step R14, the terminal connecting unit 6 provides the execution data of the service after converted to an originating terminal of the restart request. FIG. 3 shows an operation which corresponds to a request acceptance from a terminal on one by one time basis in a process for the seamless system to continuously operate, wherein a state of waiting for a request from a terminal again is established after arrival at END, and the flow chart of FIG. 3 is repeated upon the receipt of a next request from the terminal. In addition, after type of requesting termination has been added as request type, in the case where the request type is “terminate”, an operation for terminating the repetition of the flow chart of FIG. 3 may be carried out.

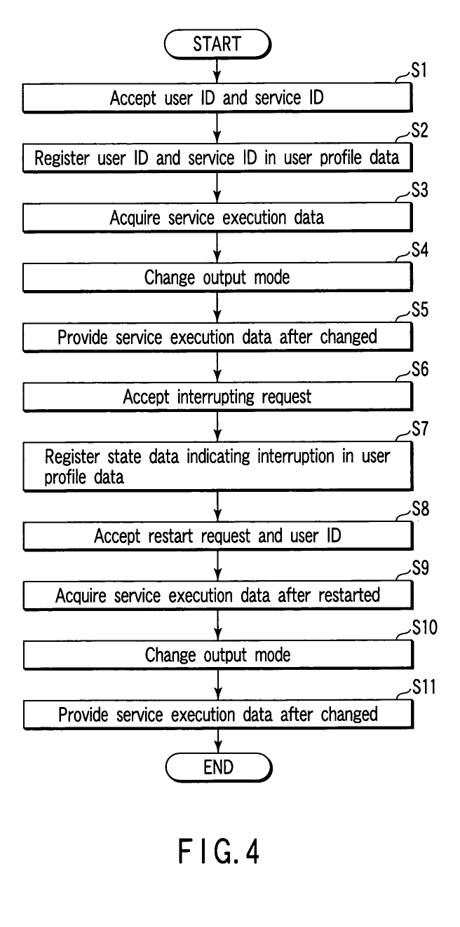

FIG. 4 is a flow chart showing an example of general processing of the seamless system 1 according to the present embodiment. FIG. 4 shows a flow of process in the case where service starting, interruption, and restarting have been requested.

In step S1, the terminal connecting unit 6 accepts a user ID and a service ID from the user operated terminal.

In step S2, the terminal connecting unit 6 includes the user ID and service ID in the user profile data 5a and manages these IDs.

In step S3, the starting unit 7a acquires the execution data on the service which corresponds to the service ID until an interrupting request has been received from a terminal.

In step S4, the terminal connecting unit 6 converts the execution data acquired by the starting unit 7a into an output mode of a terminal by utilizing the optimizing unit 8.

In step S5, the terminal connecting unit 6 provided the execution data after converted to a terminal.

In step S6, the terminal connecting unit 6 accepts an interrupting request from a terminal.

In step S7, the interrupting unit 7b registers the state data indicating interruption of the service which corresponds to the service ID in the user profile data 5a.

In step S8, the terminal connecting unit 6 accepts a restarting request and a user ID.

In step S9, the restarting unit 7c acquires the execution data on the service of the service ID associated with the user ID, the state data of which indicates interruption, based on the user profile data 5a, and acquires the execution data on the service after restarted, based on the attribute data.

In step S10, the terminal connecting unit 6 converts the execution data on the service after restarted, the service being acquired by the restarting unit 7c, into an output mode of an originating terminal requesting restarting, by utilizing the optimizing unit 8.

In step S11, the terminal connecting unit 6 provides the execution data on service after converted to an originating terminal requesting restarting.

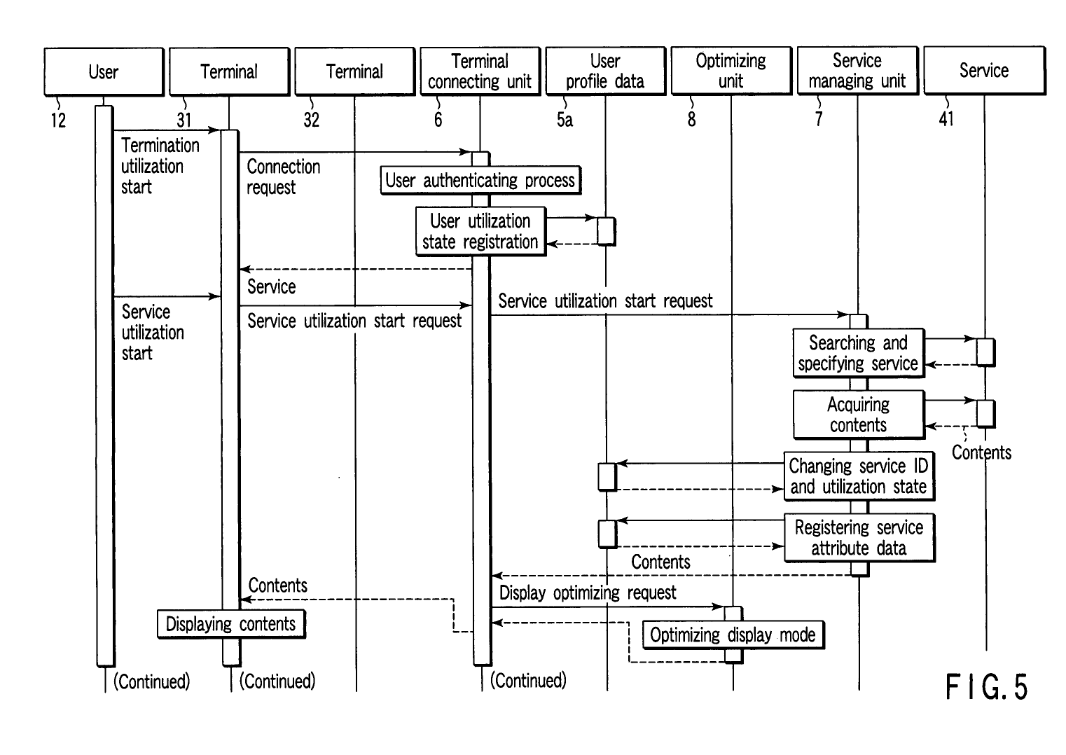

A detailed operation of the seamless system 1 as described above will be described with reference to FIGS. 5 to 7.

FIGS. 5 to 7 each show a case in which interruption of service by a terminal 31 is canceled, and the same service is utilized again by a terminal 32 which is different from that before interrupted. In addition, with respect to FIGS. 5 to 7, a description will be given assuming that execution of processing for carrying out a service 41 for distributing contents has been requested.

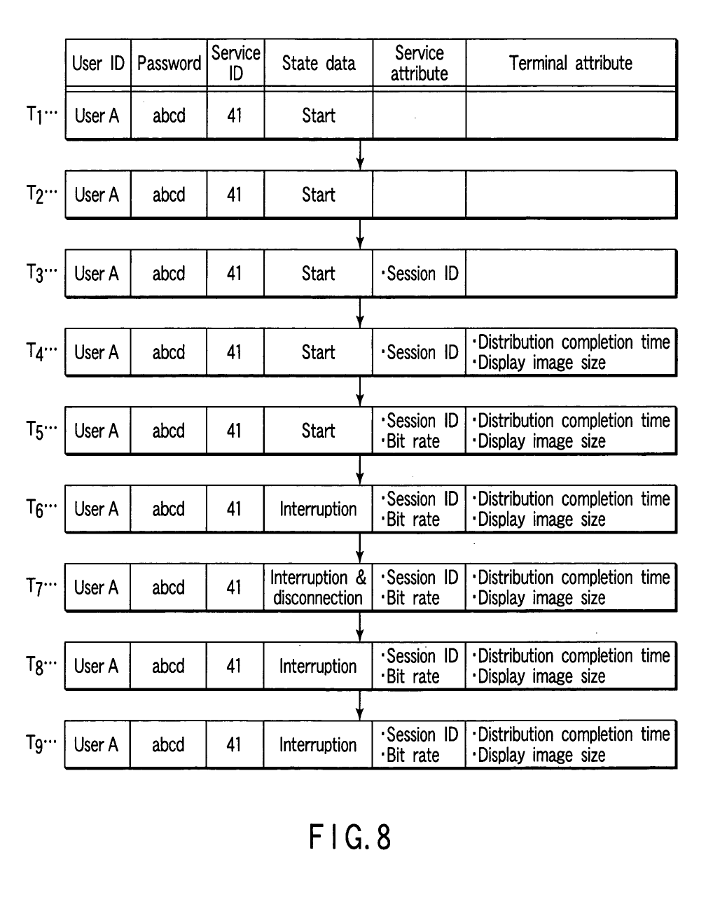

FIG. 8 is a view showing an example of a changing state of the user profile data 5a.

FIG. 5 is a sequence chart showing an example of operation from connection of the terminal 31 to starting service.

First, a user 12 starts utilization of the terminal 31 and operates the terminal 31 to make connection to the seamless system 1.

The terminal connecting unit 6 having accepted a connection request carries out the user authentication processing, and specifies the user 12 having requested connection.

An arbitrary technique can be applied to the user authentication processing. For example, as the user authentication processing, the user ID and password are managed by the user profile data 5a, and the user ID and password are accepted from the terminal 31 during a connection request. Then, when the accepted user ID and password match the user ID and password of the user profile data 5a, authentication completes.

Next, the terminal connecting unit 6 registers the state data indicating that the user 12 has entered the utilization start state in the user profile data 5a. The contents of the user profile data 5a at this time point are obtained as a state T₁ of FIG. 8.

When connection completes, the user 12 provides the service ID and service utilization start request to the seamless system 1 through the terminal 31. The service ID and service utilization start request are accepted by the service managing unit 7 via the terminal connecting unit 6. In FIG. 5, execution of the service 41 is requested by the user 12.

The starting unit 7a of the service managing unit 7 searches and specifies where the service 41, the utilization start of which has been requested by the user 12, is, and acquires the contents provided by that service 41.

For example, in the case where a plurality of screen transitions occurs or in the case of a streaming service for continuously providing data which continuously changes with an elapse of time, the starting unit 7a of the service managing unit 7 acquires the first display of the contents.

The starting unit 7a of the service managing unit 7 records information indicating that the user 12 utilizes the service 41 in the user profile data 5a. For example, the starting unit 7a records a service ID in the user profile data 5a. The contents of the user profile data 5a at this time point are obtained as a state T₂ of FIG. 8.

Further, when the attribute data which must be retained by the terminal 31 in utilizing the service 41 has been sent from the service 41, the starting unit 7a of the service managing unit 7 relays this attribute data to the terminal 31 and resisters the data in the user profile data 5a.

For example, when a service displays a plurality of screens, there is generally used a method for a terminal and a server providing a service to share a session ID. In the case of using this method, the session ID is provided from the server providing a service to a client terminal. This session ID is recorded as attribute data in the user profile data 5a.

The contents of the user profile data 5a at this time point are obtained as a state T₃ of FIG. 8. In this state T₃, a session ID is recorded as a value of item “service attribute”.

The terminal connecting unit 6 provides the contents provided from the starting unit 7a of the service managing unit 7 to the optimizing unit 8; converts the contents into a mode which coincides with a display specification of the terminal 31; and provides the contents after converted to the terminal 31.

The terminal 31 displays the accepted contents. The user 12 makes an operation for that display, and occasionally request a next screen display.

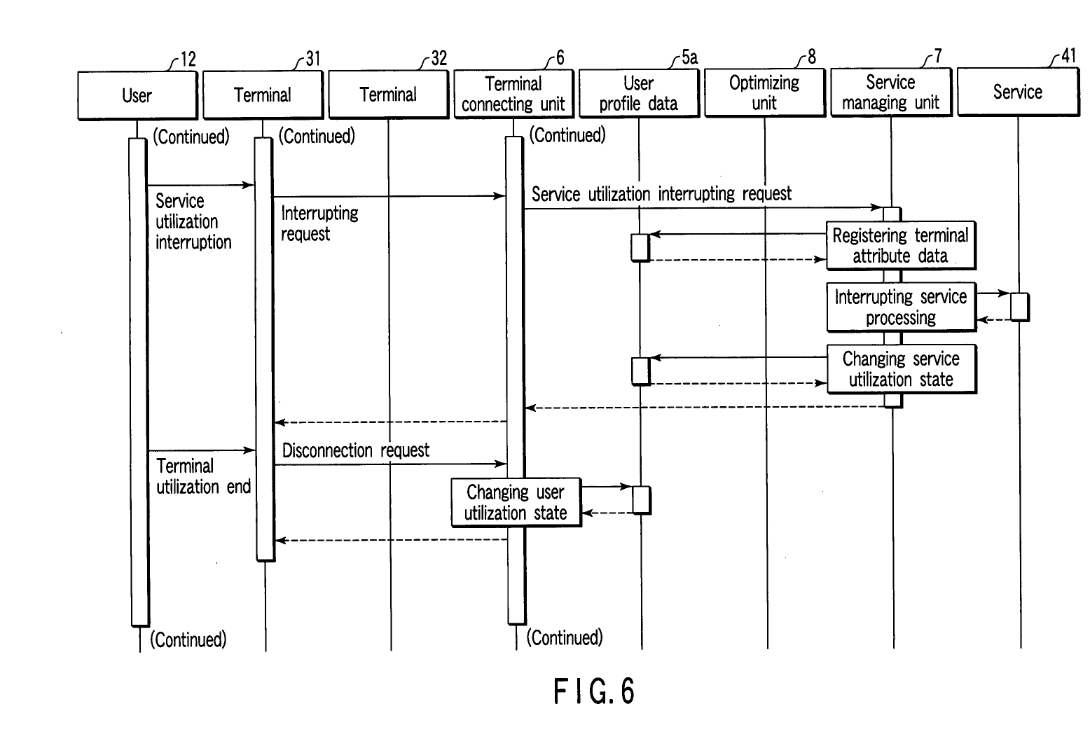

FIG. 6 is a sequence chart showing an example of operation in the case of interrupting the service 41 utilized by the user 12.

First, an interrupting request from the terminal 31 operated by the user 12 is provided to the service managing unit 7 via the terminal connecting unit 6. The terminal 31 adds a variety of attribute data (terminal attributes) retained by the terminal 31 to the interrupting request, and provides the added data to the service managing unit 7. For example, the terminal attributes include the display size and the streaming reproduction completion time at the terminal 31.

The interrupting unit 7b of the service managing unit 7 registers the terminal attribute added to the interrupting request in the user profile data 5a. It is not mandatory to manage the terminal attribute in the user profile data 5a.

The contents of the user profile data 5a at this time point are obtained as a state T₄ of FIG. 8.

The interrupting unit 7b of the service managing unit 7 having accepted an interrupting request carries out a process of interrupting the service 41. The process of interrupting the service 41 includes a process of reproduction stop of a stream service, for example. The process of interrupting the service 41 may not be carried out if any problem occurs, depending on the contents of operation of the service 41.

Next, the interrupting unit 7b of the service managing unit 7 records data relating to an execution state of the interrupted service 41 in the user profile data 5a. The data relating to a service execution state includes: reproduction completion time data of a streaming service; cookie information utilized before interruption in a service to be interrupted; a bit rate; and data inputted by a user.

The contents of the user profile data 5a at this time interval are obtained as a state T₅ of FIG. 8.

The interrupting unit 7b of the service managing unit 7 registers state data indicating that the service 41 has been interrupted by the user 12 in the user profile data 5a, and completes an interrupting process. The contents of the user profile data 5a at this time point are obtained as a state T₆ of FIG. 8.

After the process of interrupting the service 41 has terminated, the terminal 31 operated by the user 12 provides to the seamless system 1 a request for disconnecting a connection between the seamless system 1 and a server providing a service. The terminal connecting unit 6 registers the state data indicating that a disconnection state has been established with respect to the user 12 in the user profile data 5a.

The contents of the user profile data 5a at this time point are obtained as a state T₇ of FIG. 8.

A change to the state T₇ may be omitted. In this case, the state data indicating a state in which the user operation has been interrupted while connection is maintained without moving to the disconnection state is registered in the user profile data 5a.

The utilization of the terminal 31 may terminate without a disconnection request such as cutting off the power of the terminal 31 being provided to the seamless system 1. In this case, the contents of the user profile data 5a are not changed.

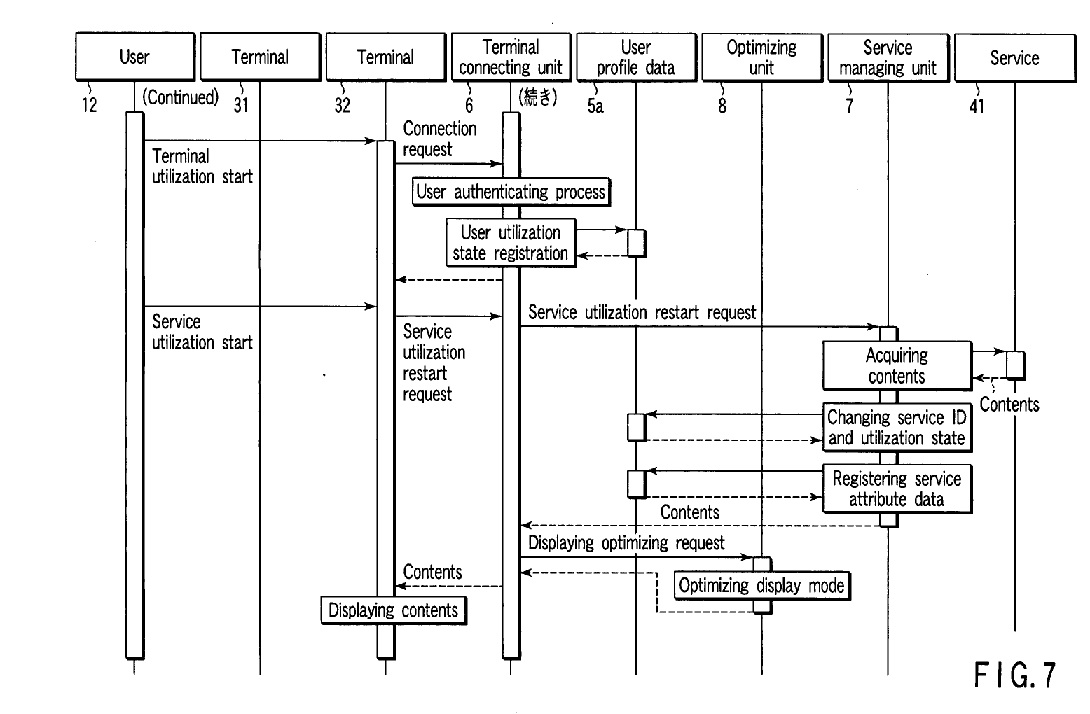

FIG. 7 is a sequence chart showing an example of operation in the case where the user 12 requests restarting of the service 41 by utilizing the terminal 32.

First, the user 12 operates the terminal 32 to provide a connection request to the terminal connecting unit 6. Then, the terminal connecting unit 6 carries out user authentication by means of the user authentication processing in the same way as in the case of FIG. 5.

The terminal connecting unit 6 registers the state data indicating that the user 12 has been disconnected in the user profile data 5a.

The contents of the user profile data 5a at this time point are obtained as a state T₈ of FIG. 8. In this state T₈, a value of item “state data” is changed from “interruption & disconnection” to “interruption”.

When the fact that the user profile data 5a has a service in interruption is indicated, the terminal connecting unit 6 may provide to the terminal 32 the data indicating which service is interrupted. When a state in which a plurality of services in interruption exist is permitted for one user 12, in order for the user 12 to determine which service being interrupted is restarted, the terminal connecting unit 6 provides to the terminal 32 the data indicating which service is being interrupted, whereby a process for selecting a service for requesting restarting of utilization to the user 12 may be executed.

In addition, the terminal connecting unit 6 may provide the execution data on all the services being interrupted in order to redisplay all the services being interrupted in different windows with respect to a terminal capable of displaying multi-windows.

Next, when the user 12 operates the terminal 32 to request restarting of utilization of a service being interrupted, a utilization restart request is provided to the service managing unit 7 via the terminal connecting unit 6.

The restarting unit 7c of the service managing unit 7 selects a service being interrupted based on the state data of the user profile data 5a according to a utilization restart request; privies an access to the service 41 by utilizing a variety of attribute data registered in the user profile data 5a; and acquires the contents which serve as a continuation of the contents displayed immediately before interruption.

When a service attribute has been accepted from the service 41, the restarting unit 7c of the service managing unit 7 records the service attribute in the user profile data 5a.

The restarting unit 7c of the service managing unit 7 records the state data indicating that the service 41 has been restarted in the user profile data 5a, and provides the contents after restarted to the terminal connecting unit 6.

The contents of the user profile data 5a at this time point are obtained as a state T₉ of FIG. 8.

The terminal connecting unit 6 carries out optimization of a display mode of contents by means of the optimizing unit 8, and provides the contents after converted to the terminal 32. In this manner, even if the terminal 31 and the terminal 32 apply different input/output specifications, execution of the service 41 can be transferred regardless of the difference in specifications.

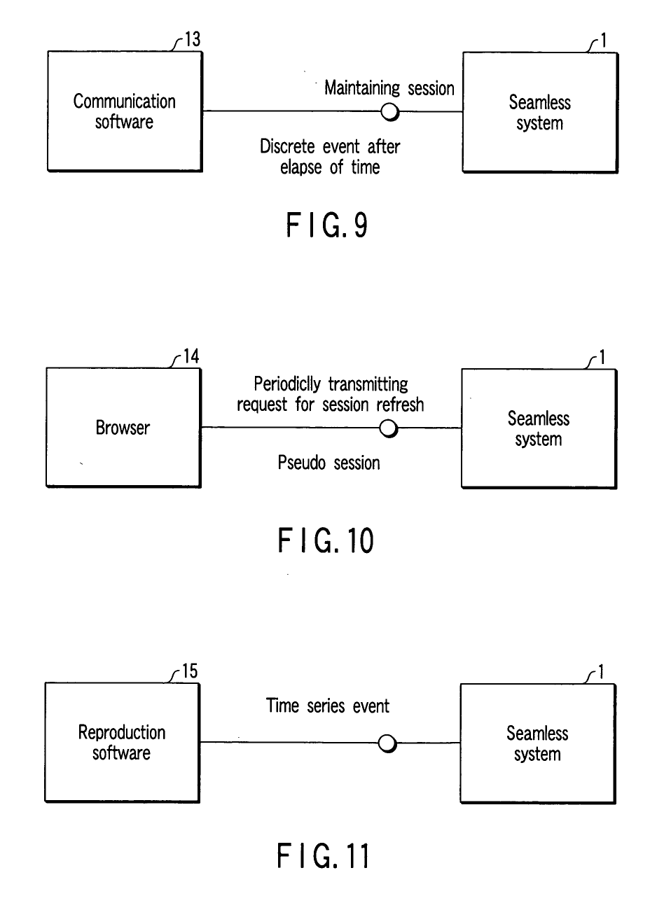

FIG. 9 is a block diagram depicting a first service continuation example using the seamless system 1.

Discrete events are transmitted and received between communication software 13 of a terminal before interrupted and the terminal connecting unit 6 of the seamless system 1 with an elapse of time, and a service is provided.

The terminal connecting unit 6 maintains a session utilized in communication between the communication software 13 of the terminal before interrupted and the seamless system 1 even after service interruption.

Input data provided from the communication software 13 of the terminal being interrupted and the seamless system 1 is recorded by the seamless system 1.

When the service is interrupted, and then, is restarted, the restarting unit 7c of the seamless system 1 executes a service by using the recorded input data. Then, the terminal connecting unit 6 transmits the execution data on the executed service to the communication software 13 of an originating terminal requesting restarting by utilizing the maintained session.

When the execution data immediately before interrupted has been registered in the user profile data 5a, the restarting unit 7c acquires the execution data immediately before interrupted, whereby the terminal connecting unit 6 may provide the execution data immediately before interrupted to the originating terminal requesting restarting.

In this manner, the user can continuously receive a service by making reconnection to the seamless system 1.

FIG. 10 is a block diagram depicting a second service continuation example using the seamless system 1.

Pseudo session management is carried out between a browser 14 of a terminal before interrupted and the seamless system 1. When a predetermined time communication is not made between the browser 14 of the terminal before interrupted and the seamless system 1, a session time-out occurs.

In the case of interrupting a service, the terminal connecting unit 6 periodically generates a request for session refreshing, prevents a session time-out, and maintain a session.

When a service is interrupted, and then, is restarted, the terminal connecting unit 6 makes connection to the browser 14 of the originating terminal requesting restarting by utilizing the maintained session. In this manner, the user can continuously utilize the interrupted service by means of the browser 14.

FIG. 11 is a block diagram depicting a third service continuation example using the seamless system 1.

Continuous events with an elapse of time are transmitted and received between reproduction software 15 of a terminal before interrupted and the terminal connecting unit 6 of the seamless system 1, and a service is provided. Here, assume that contents for streaming service are provided from the seamless system 1 to the reproduction software 15.

The terminal connecting unit 6 maintains a session between the reproduction software 15 and the seamless system 1 even after service interruption.

The interrupting unit 7b of the seamless system 1 records a reproduced point before interruption.

When the streaming service itself comprises an interrupting function, the restarting unit 7c specifies the reproduced point for the streaming service, and instructs restarting.

When the streaming service itself does not comprise the interrupting function, the restarting unit 7c temporarily accepts contents from the stream service, and acquires a portion after the reproduced point. Then, the terminal connecting unit 6 transmits the portion after the reproduced point to the reproduction software 15 of the originating terminal requesting restarting.

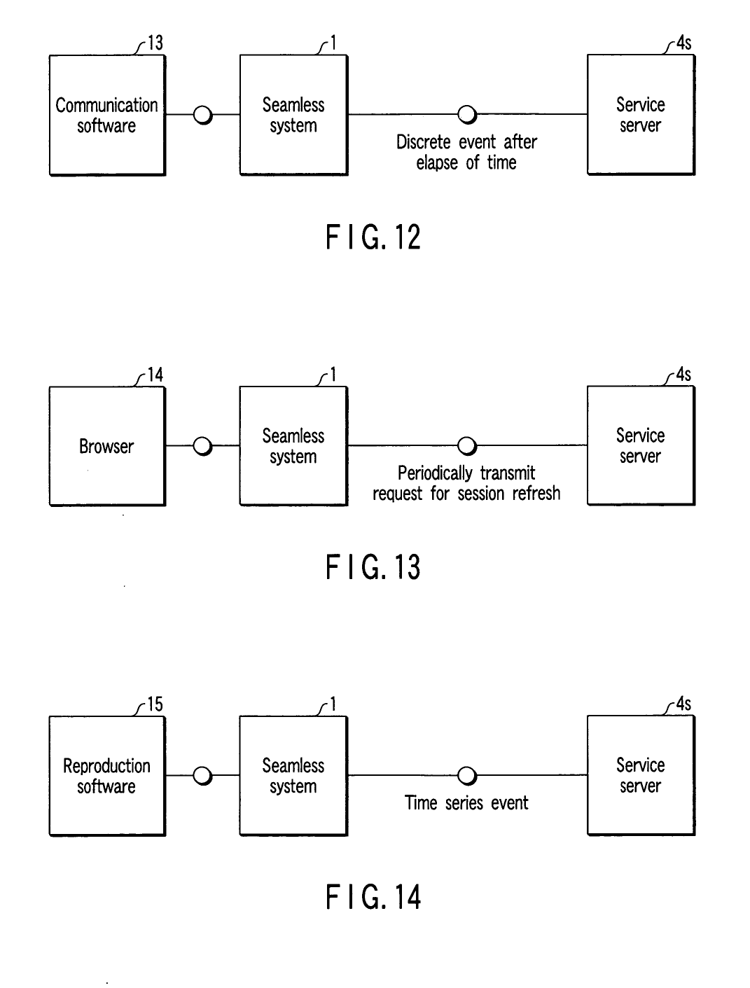

As shown in FIGS. 12 to 14, the seamless system 1 maintains a session between the seamless system 1 and the service server 4a which provides a service by means of a technique similar to those of FIGS. 9 to 11, whereby a service may be continued.

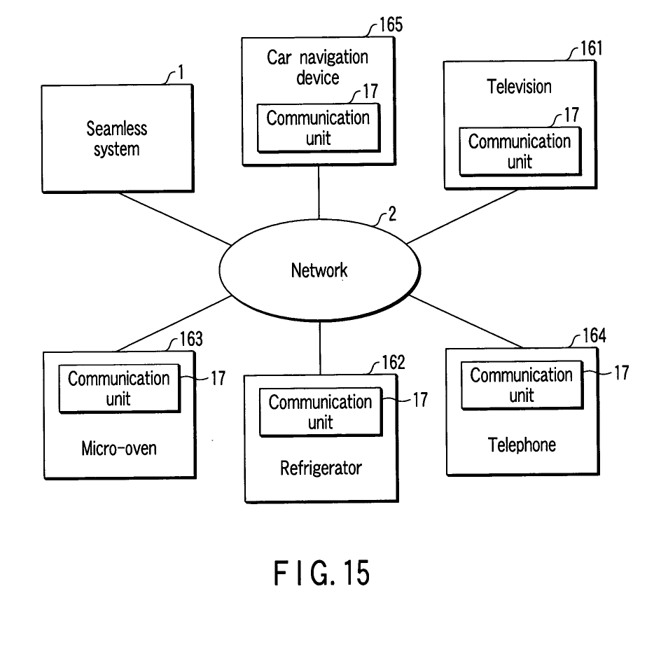

FIG. 15 is a block diagram depicting an example in which the seamless system 1 according to the present embodiment has been applied to a ubiquitous system.

In the ubiquitous system, for example, a communication unit 17 is provided to a variety of devices such as a television 161, a refrigerator 162, a micro-oven 163, a telephone 164, and a car navigation device 165. The variety of devices can be used as terminals of a computer network system.

By applying the seamless system 1 to such a ubiquitous system, even if one device interrupts a work, another device can restart the work properly, speedily, and easily. For example, the work which has been carried out by the television 161 can be continued by the telephone 164.

In addition, even if an input mode and an output mode are different from another ones, the user can make an input or an output suitable to a device operated at that time point.

A variety of devices such as a desk top computer, a hand held computer, a hand held cellular phone, a game machine, a PDA (Personal Digital Assistant), and an audio device can be utilized as terminals of the ubiquitous system.

In the present embodiment as described above, even if the user operated terminal is changed, the service at the terminal before changed can be transferred to the terminal after changed, and service continuation can be achieved.

When the work interrupted at one terminal is restarted at another terminal, an input and output terminal (for example, a keyboard, a mouse, a display or the like) comprising the terminal whose work has been interrupted or a display format is not always the same as an input and output device comprising a terminal restarting a work or a display format. In such a case, in the present embodiment, the data suitable to a terminal can be provided from the seamless system 1 to the terminal by the optimizing unit 8.

Constituent elements described in this embodiment may be freely combined or may be divided into a plurality of elements.

In addition, the terminal connecting unit 6, service managing unit 7, and optimizing unit 8 according to this embodiment may be implemented by hardware.

Although the embodiment describes an example of managing two types of data consisting of the “service attribute” and “terminal attribute” as shown in FIG. 2 as attribute data, only either of these two types of data may be managed.

For example, when only the service attribute is utilized, although information managed at the terminal side such as a display size on terminal is lost, an attribute value of data provided from the service 41 to the terminal immediately before interrupted is stored as a service attribute. Thus, processing of the service 41 can be restarted. In addition, a terminal is forcibly disconnected from a network without carrying out an interrupting process. Even if the terminal attribute is not registered in the user profile data 5a, a minimum restarting process can be carried out.

For example, when only the terminal attribute is utilized, there is a case in which information corresponding to the service attribute is retained in the terminal as well. The information corresponding to the service attribute is registered as a terminal attribute from the terminal during the interrupting process, whereby processing of the service 41 can be restarted.

In addition, in the present embodiment, as shown in FIG. 2 described above, although state data is managed in the user profile data 5a, it is not mandatory to manage the state data. In the case where the state data is not managed, in the restarting process of FIG. 7 described above, all the restarting states are established with respect to the service ID corresponding to the user ID accepted from the terminal, whereby the interrupted process can be restarted without managing the state data.

In the present embodiment, although there is shown an example of registering information in the user profile data, and then, using a user ID as information serving as a key used during restarting of processing, there may be utilized information other than the user ID which specify required information from among the user profile data. For example, a device ID uniquely assigned for each device serving as a terminal, for example, is managed by the user profile data in the same manner as the user ID, thereby making it possible to utilizing a role which is similar to a role which the user ID in the present embodiment serves. Further, for example, it is also possible to utilize a service ID recorded in the user profile during the interrupting process, for example. The fact that information other than the user ID can be utilized as means for specifying the information contained in the user profile data is similar in the embodiments described below.

(Second Embodiment)

In this embodiment, a description will be given with respect to a modified example of the seamless system 1 according to the first embodiment.

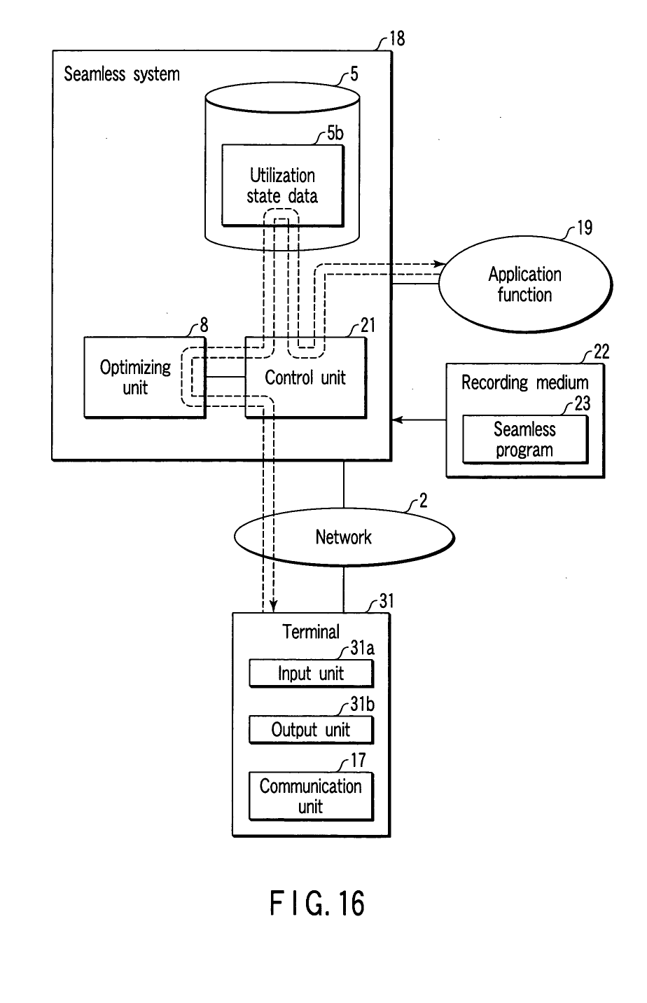

FIG. 16 is a block diagram depicting an example of a configuration of a seamless system according to the present embodiment.

A terminal 31 comprises: an input unit 31a which accepts an input from a user; an output unit 31b which outputs execution data of processing to the user; and a communication unit 17 which controls communication with a seamless system 18.

The seamless system 18 is connected to be communicable with the terminal 31 via a network 2, and is connected to an application function 19 (processing process or thread) which provides a service. The application function 19 may exist on the same hardware as the seamless system 18 or may exist on another hardware. The application function 19 and the seamless system 18 may be connected to each other via the network 2.

The seamless system 18 comprises a recording unit 5, a control unit 21, and an optimizing unit 8.

The seamless system 18 reads and executes a seamless program 23 recorded in a recording medium 22, thereby achieving a function as the control unit 21 and the optimizing unit 8.

In the present embodiment, the seamless program 23 may operate on a single server computer, for example, or may operate while the seamless program is linked with another seamless program in a state in which they are distributed on a plurality of computers.

The recording unit 5 records utilization state data 5b.

The control unit 21 includes functions which serve as the service managing unit 7 and the terminal connecting unit 6 according to the first embodiment.

An outline of the seamless system 18 as described above will be described here.

The terminal 31 provides an operating request and a terminal type including a user ID of a user operating the terminal 31 to the seamless system 18, and requests execution of processing in a format according to one's own type.

The control unit 21 of the seamless system 18 having accepted the processing request and terminal type from the terminal 31 passes the type of the terminal 31 and the operating request to the optimizing unit 8.

The optimizing unit 8 converts the processing request into a format of the seamless system 18 based on the type of the terminal 31 accepted from the control unit 21, and returns the converted request to the control unit 21.

The control unit 21 references the utilization state data 5b, and executes a user authenticating process based on a user ID included in the processing request.

When the user is not authenticated, the control unit 21 requests the user authentication data for the terminal 31.

In response to a request for the authentication data from the control unit 21, the terminal 31 provides the user authenticating data to the seamless system 18.

The control unit 21 of the seamless system 18 accepts the authenticating data from the terminal 31.

The control unit 21 carries out the user authentication process based on the authenticating data.

When the user is authenticated, the control unit 21 registers a result in the utilization state data 5b; forms a processing request together with a processing request after input and output format conversion and the utilization state data 5b, and passes them to the application function 19.

In the case where the user has been authenticated by the control unit 21, it is assumed that the application function 19 has accepted the past user processing request and the process corresponding to the accepted processing request has been executed to the user.

Therefore, in the case where the user has been authenticated by the control unit 21, the application function 19 continues the past process based on the accepted processing request. When the past processing terminates, a state of waiting for a next processing request is established.

On the other hand, in the case where the user is not authenticated by the control unit 21, the control unit 21 passes an application authenticating request and a processing request after input and output format conversion to the application function 19.

When the user is not authenticated by the control unit 21, the application function 19 accepts the application authenticating request from the control unit 21, and executes the application authenticating process.

In the case where the application authenticating process is thus executed, it is assumed that the application function 19 has not accepted the past processing request from the user and the processing corresponding to the currently accepted processing request has not been executed to the user yet.

Therefore, the application function 19 newly starts processing according to the processing request, and, when processing terminates, a state of waiting for a next processing request is established.

In the above-described example, the application authenticating request and the processing request after input and input format conversion are provided from the control unit 21 to the application function 19 at one time. However, the application authenticating request and the processing request after input and output format conversion may be provided separately from the control unit 21 to the application function 19. In this case, after the authenticating process has been carried out based on the application authenticating request, the processing request after input and output format conversion is provided from the control unit 21 to the application function 19.

The application function 19 returns the execution data obtained by execution of processing to the control unit 21.

The control unit 21 stores processing state data in the utilization state data 5b, and passes the execution data to the optimizing unit 8 together with terminal type.

The optimizing unit 8 converts the execution data accepted from the control unit 21 into a format according to type of the terminal 31, and returns the converted data to the control unit 21.

The control unit 21 provides to the terminal 31 the execution data after converted, the execution data being accepted from the optimizing unit 8.

The terminal 31 displays the execution data accepted from the seamless system 18.

In the present embodiment described above, the user can easily inherit the interrupted processing.

Constituent elements described in the present embodiment may be freely combined or may be divided into a plurality of elements.

In addition, the control unit 21 and optimizing unit 8 according to this embodiment may be implemented by hardware.

(Third Embodiment)

In this present embodiment, a description will be given with respect to a seamless system which provides a seamless work environment with respect to only a specific service between a plurality of terminals.

A configuration of the seamless system according to the present embodiment is similar to that of FIG. 1.

It is an object of the present embodiment to achieve a seamless work with respect to only a specific service. Therefore, the seamless system according to the embodiment is connected to only such a specific service so as to enable transmission and receiving via a network or retains only such a specific service as a local service.

In the seamless system according to the embodiment, only one service is provided, thus making it possible to eliminate management of a service ID and state data.

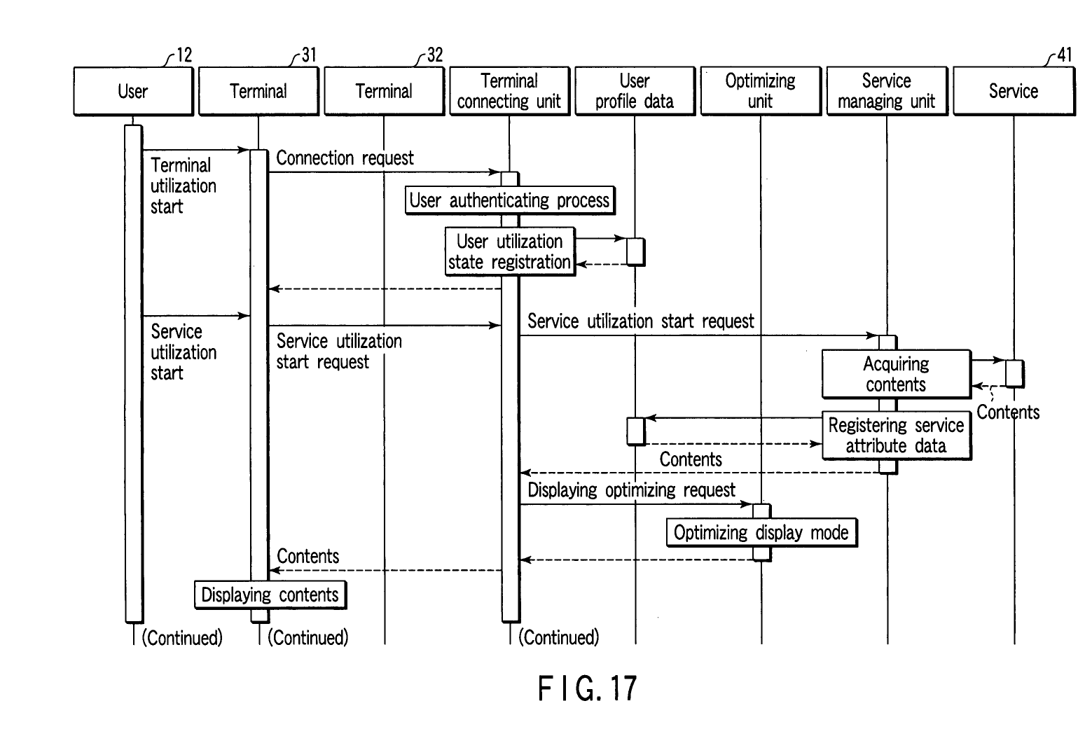

A detailed operation of the seamless system according to the present embodiment will be described with reference to FIGS. 17 to 19.

FIGS. 17 to 19 each show a case in which the utilization of the service 41 by the terminal 31 of the user 12 is interrupted, and the same service 41 is utilized again at a terminal 32 which is different from that before interrupted.

In addition, with respect to FIGS. 17 to 19, a description will be given assuming that execution of processing for achieving the service 41 for distributing contents has been requested.

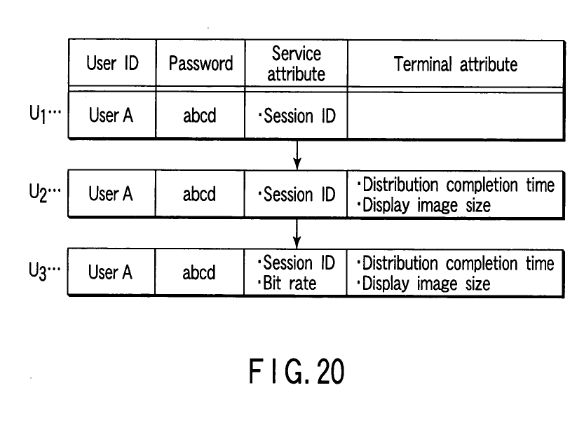

FIG. 20 is a view showing an example of a changing state of contents of the user profile data.

FIG. 17 is a sequence chart showing an example of operation from connection of the terminal 31 to starting of service.

First, the user 12 starts utilization of the terminal 31 and operates the terminal 31 to make connection to the seamless system.

The terminal connecting unit having accepted a connection request carries out the user authenticating process and specifies the user 12 having requested connection.

When connection completes, the user 12 provides a service utilization start request to the seamless system through the terminal 31. This service utilization start request is provided to the service managing unit via the terminal connecting unit.

The starting unit of the service managing unit acquires the contents provided by the service 41 whose utilization start is requested by the user 12.

When attribute data which must be retained by the terminal 31 when utilizing the service 41 has been provided from the service 41, this attribute data is relayed to the terminal 31 and is registered in the user profile data. The starting unit of the service managing unit records a session ID as attribute data in the user profile data, for example.

The contents of the user profile data at this time point are obtained as a state U₁ of FIG. 20. In this state U₁, the session ID is recorded as a value of item “service attribute”.

The terminal connecting unit provides to the optimizing unit the contents provided from the starting unit of the service managing unit; converts the contents to a mode matching a display specification of the terminal 31; and utilizes the contents after converted to the terminal 31.

The terminal 31 displays the contents accepted from the service 41 via the seamless system. The user 12 makes an operation in response to the display, and requests a next screen as required.

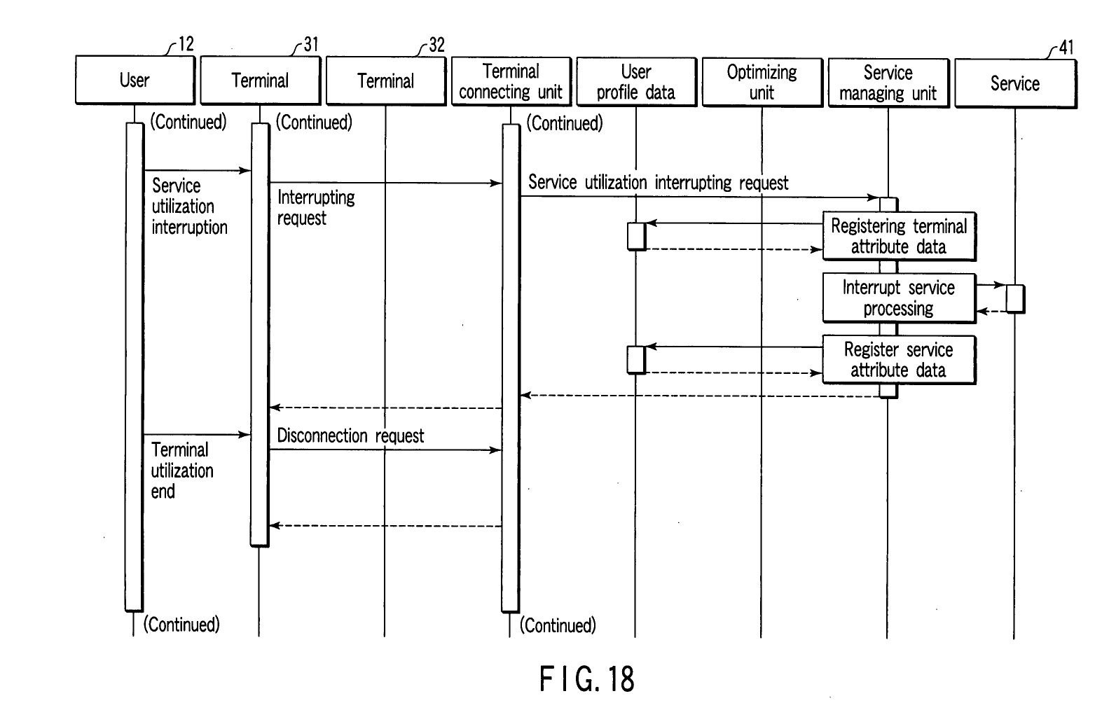

FIG. 18 is a sequence chart showing an example of operation in the case where the user 12 interrupts the service 41 being utilized.

First, from the terminal 31 operated by the user 12, an interrupting request is provided to the service managing unit via the terminal connecting unit. The terminal 31 adds a variety of attribute data (terminal attributes) retained at the terminal 31 to the interrupting request, and provides the added data to the service managing unit.

The interrupting unit of the service managing unit registers the terminal attribute added to the interrupting request in the user profile data. It is not mandatory to manage the terminal attribute in the user profile data.

The contents of the user profile data at this time interval are obtained as a state U₂ of FIG. 20.

The interrupting unit of the service managing unit having accepted an interrupting request carries out a process of interrupting the service 41.

Next, the interrupting unit of the service managing unit records data relating to an execution state of the interrupted service 41 in the user profile data, and completes the interrupting process.

The contents of the user profile data at this time point are obtained as a state U₃ of FIG. 20.

After the process of interrupting the service 41 has terminated, the user 12 transmits a request for cutting off a connection between the seamless system and the server providing a service, and the terminal connecting unit cuts off the connection. The utilization of the terminal 31 may terminate without a disconnection request such as turning OFF the power supply of the terminal 31 being provided to the seamless system.

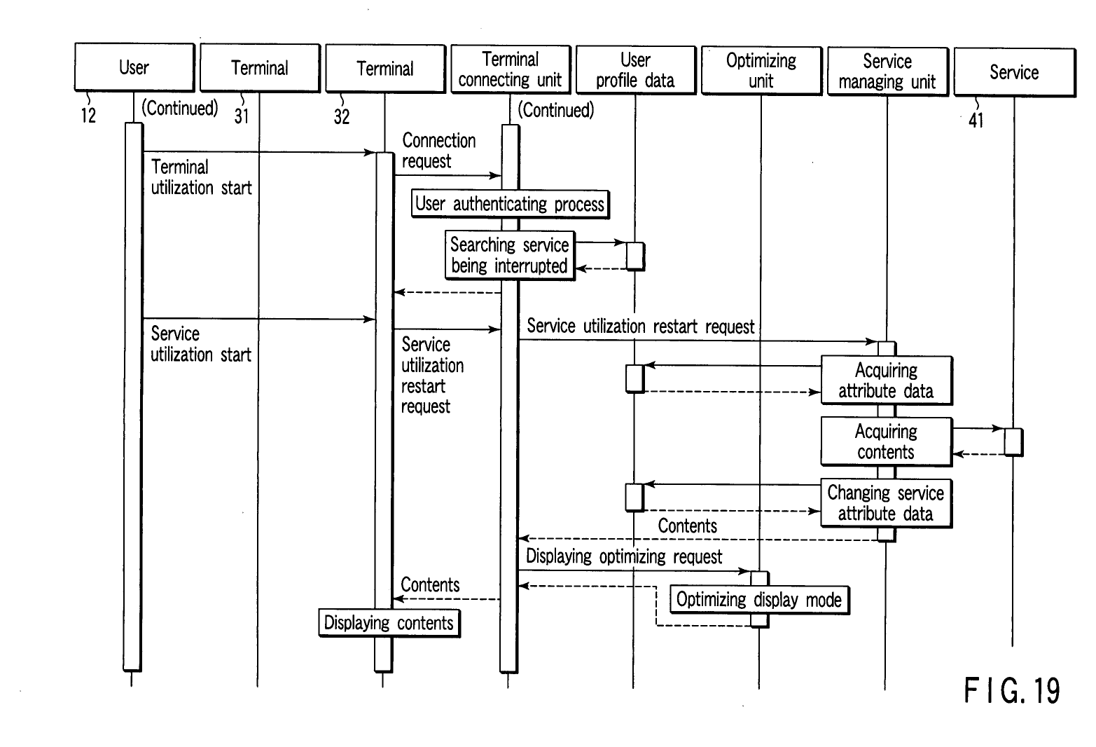

FIG. 19 is a sequence chart showing an example of operation in the case where the user 12 requests restarting of the service 41 by utilizing the terminal 32.

First, the user 12 operates the terminal 32 and provides a connection request to the terminal connecting unit. Then, the terminal connecting unit carries out user authentication. The terminal connecting unit may provide to the terminal 32 whether or not the service 41 is in interruption. For example, when attribute data remains in the user profile data, it is determined that the service 41 is in interruption.

Next, when the user 12 requests utilization restarting of the service 41 being interrupted by operating the terminal 32, the utilization restart request is provided to the service managing unit via the terminal connecting unit.

The restarting unit of the service managing unit provides an access to the service 41 by utilizing a variety of attribute data registered in the user profile data in response to the utilization restart request, and acquires the contents which becomes a continuation of the contents displayed immediately before interrupted.

When a service attribute has been sent from the service 41, the restarting unit of the service managing unit records the service attribute in the user profile data.

The restarting unit of the service managing unit provides the contents after restarted to the terminal connecting unit.

The terminal connecting unit carries out optimization of a display mode of the contents via the optimizing unit, and provides the contents after converted to the terminal 32.

In the present embodiment described above, in the case where the user operated terminal is changed with respect to a specific service, the work state at the previous terminal can be inherited by the later terminal, and continuation of the service can be achieved. In this manner, the user work efficiency can be improved.

Further, in this embodiment, the number of management items can be reduced more significantly than that in the first embodiment, and processing for restarting a work can be simplified.

(Fourth Embodiment)

In this embodiment, a description will be given with respect to a seamless system for, in the case where combinations of a plurality of services are sequentially utilized in accordance with a predetermined rule, providing an environment for achieving restarting of a work from an interrupted service.

In the embodiment, for example, after hotel reservation has been completed by utilizing a hotel reservation service, in the case where an airline ticket reservation service is utilized, if the airline reservation service is interrupted, a hotel reservation result is maintained, and a work can be restarted from the airline ticket reservation.

A configuration of deleting an interrupting unit from the seamless system shown in FIG. 1 is applied as a configuration of a seamless system according to the present embodiment.

In the seamless system according to the present embodiment, identification of the interrupted service will suffice from among a plurality of services sequentially utilized. Thus, a user ID and a service ID are managed.

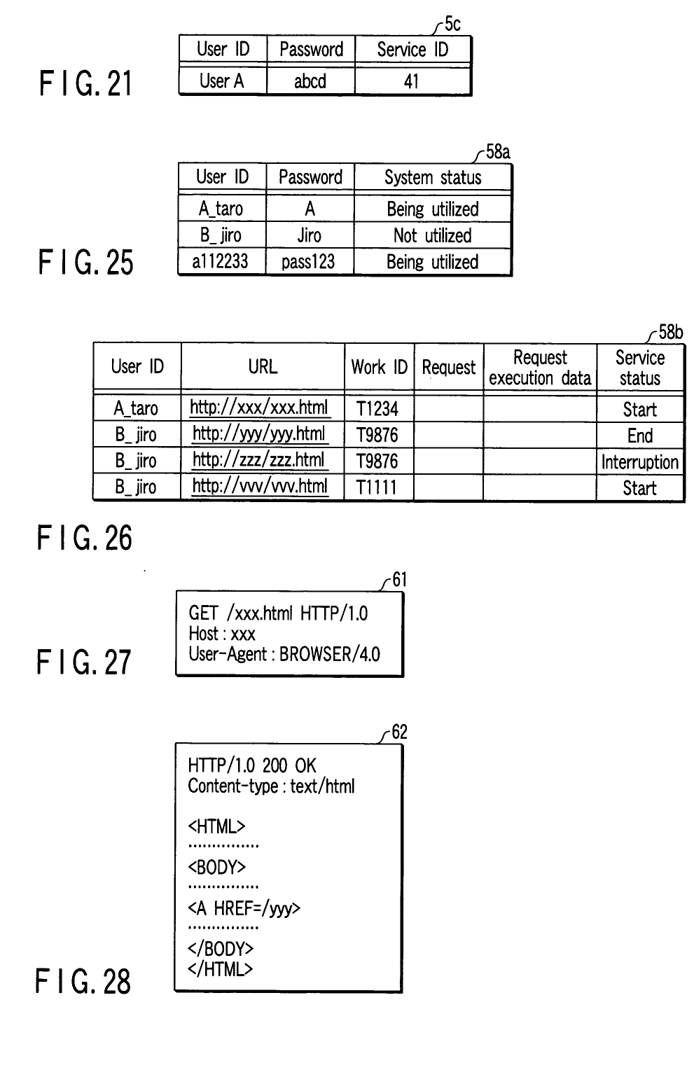

FIG. 21 shows an example of user profile data according to the present embodiment.

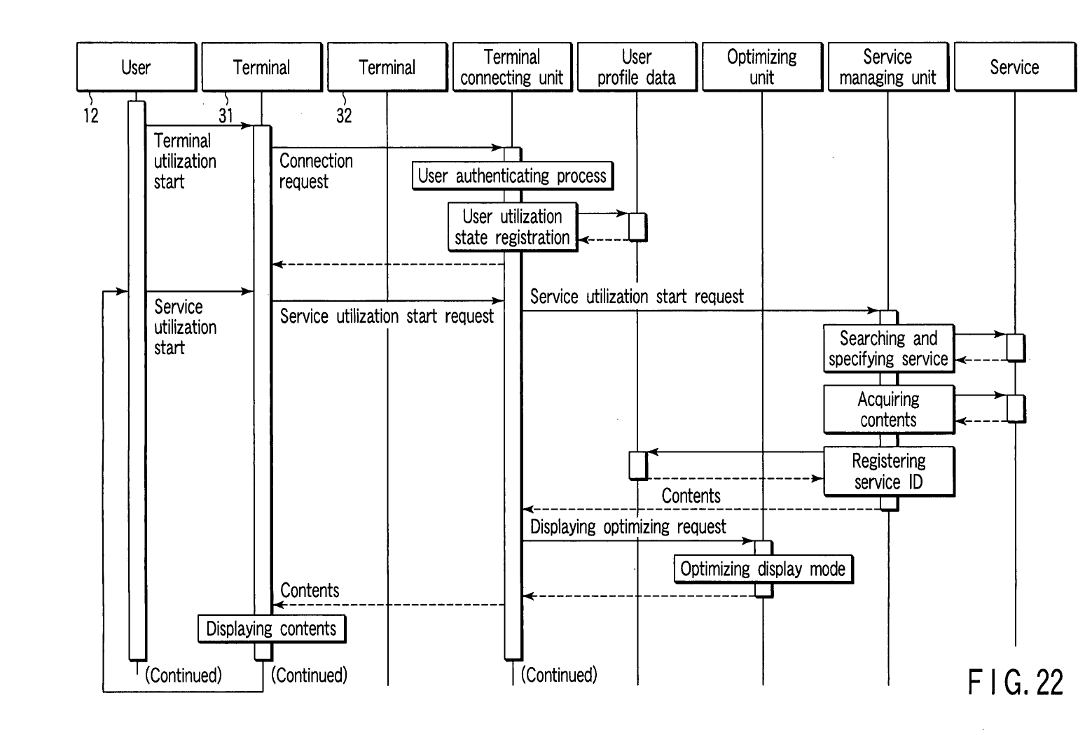

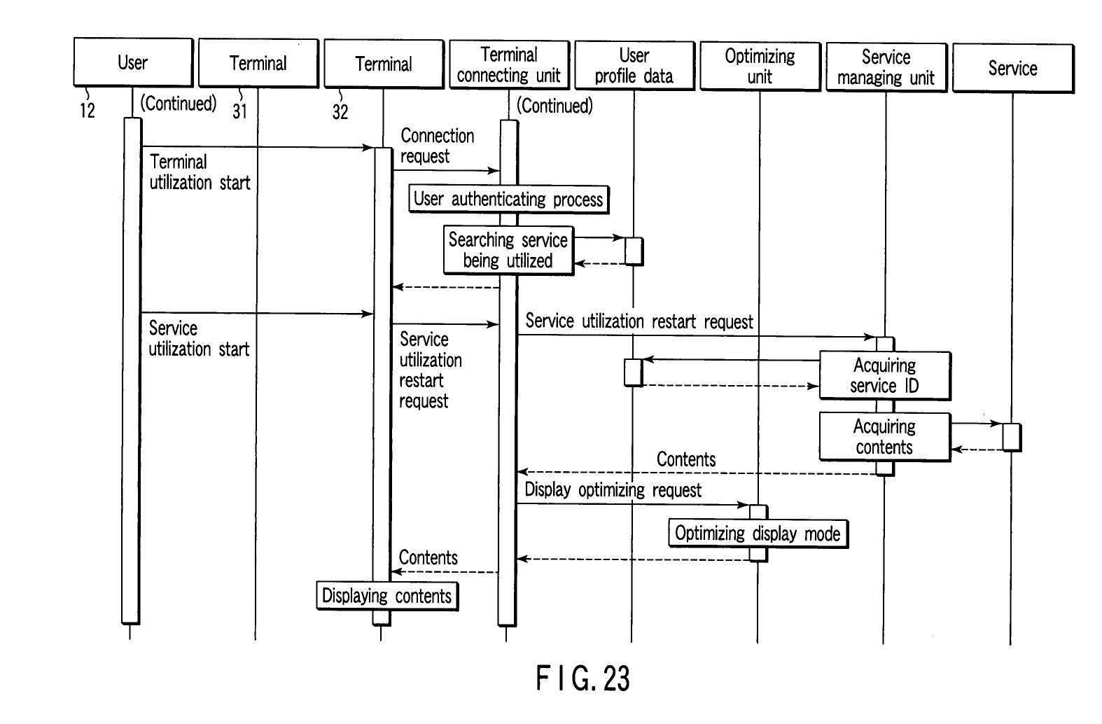

A detailed operation of the seamless system according to the embodiment will be described with reference to FIGS. 22 and 23.

FIGS. 22 and 23 each show a case in which the utilization of a service by a terminal 31 of a user 12 is interrupted, and the service interrupted by a terminal 32 which is different from that before interrupted is utilized again.

FIG. 22 is a sequence chart showing an example of operation from connection of the terminal 31 to service interruption.

First, the user 12 starts utilization of the terminal 31, and operates the terminal 31 to make connection to a seamless system 1.

A terminal connecting unit having accepted a connection request carries out a user authenticating process, and specifies the user 12 having requested connection.

When connection completes, the user 12 provides a service ID and a service utilization start request to a seamless computer through the terminal 31. The service ID and the service utilization start request are provided to a service managing unit via the terminal connecting unit.

A starting unit of the service managing unit searches and specifies where a service for the user 12 to have requested utilization start is, and acquires the contents provided by that service.

The starting unit of the service managing unit records a service ID utilized by the user 12 in the user profile data.

In FIG. 21, the contents of the user profile data 5c at this time point are presented.

Moreover, the starting unit of the service managing unit provides the acquired contents to the terminal connecting unit.

The terminal connecting unit provides to an optimizing unit the contents provided from the starting unit of the service managing unit; converts the contents into a mode matching a display specification of the terminal 31; and provides the contents after converted to the terminal 31.

The terminal 31 displays the accepted contents. The user 12 makes an operation in response to the display, and requests a next screen as required.

In the case where an operation has been moved from one service to another service, the above operation is repeated. When the operation is changed from one service to another service, a service ID of the service after changed to the user profile data 5c is registered. In the present embodiment, the service ID for specifying the service being utilized by the user is always recorded in the user profile data 5c.

FIG. 23 is a sequence chart showing an example of operation in the case where the user 12 requests restarting of a service by utilizing the terminal 32.

First, the user 12 transmits a connection request to the terminal connecting unit by operating the terminal 32.

In the case where a service ID is registered in the user profile data 5c, the terminal connecting unit may provide this service ID to the terminal 32.

Next, when the user 12 requests utilization restarting of a service being interrupted by operating the terminal 32, a utilization restart request is provided to the service managing unit via the terminal connecting unit.

The restarting unit of the service managing unit provides an access to a service indicated by the service ID registered in the user profile data 5c in response to the utilization restart request, and acquires contents which become a continuation of the contents displayed immediately before interrupted.

The restarting unit of the service managing unit provides the contents after restarted to the terminal connecting unit 6.

The terminal connecting unit carries out optimization of a display mode of contents via the optimizing unit, and provides the contents after converted to the terminal 32.

In the present embodiment described above, in the case where a plurality of services are utilized, a work can be started from the interrupted service, and the user work efficiency can be improved.

(Fifth Embodiment)

In this embodiment, a description will be given with respect to a seamless system which relays between a user operated terminal and a process for providing a service to such a terminal.

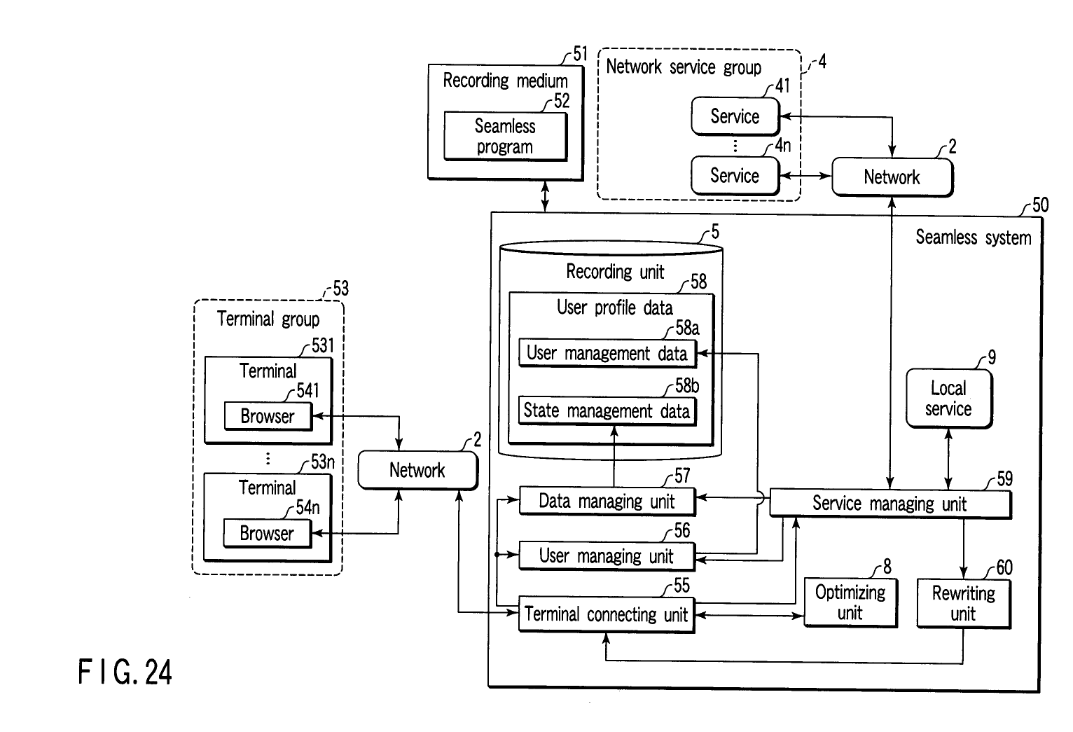

FIG. 24 is a block diagram depicting an example of a configuration of the seamless system according to the embodiment.

A seamless system 50 comprises a recording unit 5. User profile data 58 recorded in the recording unit 5 includes user management data 58a and state management data 58b.

The seamless system 50 reads a seamless program 52 recorded in a recording medium 51, and executes the read seamless program, thereby achieving functions as a terminal connecting unit 55, a user managing unit 56, a data managing unit 57, a service managing unit 59, a rewriting unit 60, and an optimizing unit 8.

The seamless program 50 may operate on a single server computer, for example, or may operate while the program is linked with another program in a state in which they are distributed on a plurality of computers.

Terminals 531 to 53n of a terminal group 53 are connected to the seamless system 50 via a network 2. The terminals 531 to 53n comprises browsers 541 to 54n, respectively.

The terminal connecting unit 55 accepts a connection request from a user operated terminal; identifies a user; carries out connection management relating to starting, interruption, restating, and termination of a service for each user; and provides the execution data on the service to the user operated terminal.

The optimizing unit 8 recognizes a specification of an input/display function for each terminal type, and optimizes a display mode or the like of the contents provided by the service for a terminal being connected.

The optimizing unit 8 is not a mandatory constituent element. For example, in the case where there is no need for converting a display mode or the like of contents in accordance with a terminal function, the optimizing unit 8 can be eliminated.

The user managing unit 56 manages user management data 58a including user profile information. The user management data 58a includes at least a user ID for specifying a user. In addition, the user management data 58a includes a password or data for specifying a user (such as certificate). The user management data 58a may manage another item of data for specifying a service providing source instead of the user ID and password. This is identical in the following case as well.

In addition, the user management data 58a may include data indicating a utilization state of the user seamless system 50.

FIG. 25 is a view showing a specific example of the user management data 58a. The user management data 58a is composed of items “user ID”, “password”, and “system status”. A value representing whether the seamless system 50 is utilized or unused with respect to a user is allocated in the item “system states”. That is, the value allocated in the item “system status” corresponds to data indicating a utilization state of the seamless system 50.

For example, a password of a user “A_taro” is “A” from the user management data 58a of FIG. 25, and a system status is “being utilized”, thus making it possible for the user to recognize that the seamless system 50 is currently used.

The data managing unit 57 of FIG. 24 manages state management data 58b including at least data which indicates a user utilization state for each user.

FIG. 26 is a view showing a specific example of the state management data 58b. The state management data 58b is composed of items “user ID”, “URL”, “work ID”, “request”, “request execution data”, and “service status”. When page identification information or the like may be added to a management item of the state management data 58b.

URL which specifies processing for providing a service is allocated in the item “URL”. URL allocated in this item “URL” corresponds to processing identification data.

Data indicating a service utilization state with respect to a user is allocated in the item “service status”. That is, in the item “service status”, data indicating in what state the service indicated by the item “URL” is established is allocated with respect to a user indicated by the item “user ID”.

Data 61 indicating a request as shown in FIG. 27, for example, is allocated in the item “request”. The data 61 indicating this request is provided as an example of data indicating a request sent from the service managing unit 59 of the seamless system 50 to host “xxx” in the case where a request for utilizing service “/xxx.html” of the host “xxx” has been sent. This example is provided as an example indicating HTTP request data for obtaining execution of the service “/xxx.html”. The “host used here provides services 41 to 4n of FIG. 24.

In this example shown in FIG. 27, although there is shown a case in which the whole HTTP request sent as the data 61 indicating a request to the host “xxx” is managed in the state management data 58b, only URL may be managed in the state management data 58b.

Execution data 62 of a service with respect to data indicating a request allocated in the item “request” as shown in FIG. 28, for example, is allocated in the item “request execution data”. The execution data 62 on the service indicated by the example of FIG. 28 is provided as an example of data sent as a result of executing the request of FIG. 27 from the host “xxx” to the seamless system 50.

Although FIG. 28 shows a case in which the whole HTTP response is managed as the execution data 62 in the state management data 58b, the execution data 62 may not be managed in the state management data 58b.

A work ID (work identification data) indicating a work (service flow) to which a service indicating the item “URL” belongs is managed in the item “work ID”.

The work used here denotes a flow of at least one process requested by a user for one purpose.

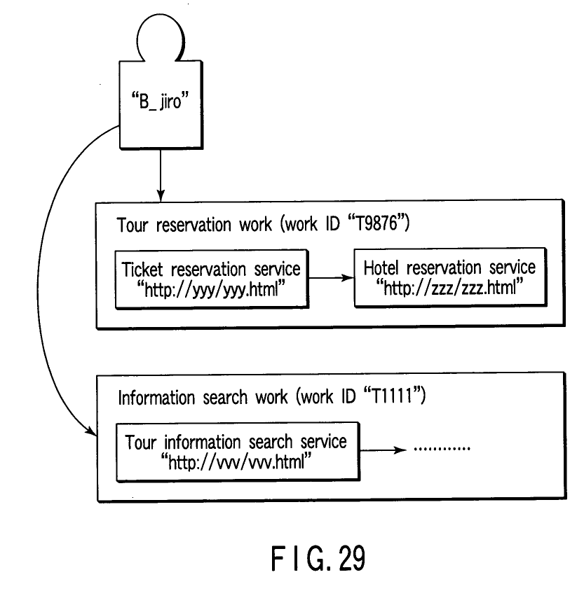

FIG. 29 shows an example of the work. For example, a series of flows of executing an airline ticket reservation service and executing a hotel reservation service is defined as a tour reservation work.

For example, from the above state management data 58b of FIG. 26, a user “B_jiro” terminates service “http://yyy/yyy.html” which belongs to work “T9876”. It is possible to recognize that service “http://zzz/zzz.html” which belongs to the work “T9876” is interrupted.

The above service managing unit 59 of FIG. 24 specifies a service whose utilization has been requested by the user from among a service group 4 on the network 2 or services 9 in a local environment, and acquires contents provided by this specified service. At least one of local services 9 and services in the network service group 4 may exist.

In addition, the service managing unit 59 makes control of service states such as start, interruption, restart, and end, and records the state management data 58b including data which indicates a service state in the recording unit 5 via the data managing unit 57.

The rewriting unit 60 rewrites hyper link information contained in the contents obtained from the network service group 4 or local service 9 in order to enable a request for management of the user service utilization state in the seamless system 50 and interruption of a work, for example, from a Web browser to the seamless system 50.

For example, the rewriting unit 60 rewrites hyper link information contained in the contents provided from the network service group 4 or local service 9 to the Web browser in order for an access to the network service group 4 or local service 9 to be provided via the seamless system 50. In this way, the hyper link information contained in the contents is rewritten so as to be provided via the seamless system 50, whereby contents or requests transmitted and received between a terminal and a service are relayed by the seamless system 50. Then, a terminal provides an access to the network service group 4 or local service 9 via the seamless system 50, thus making it possible to provide a control of a service state in the service managing unit and to record data managing a service state in the state management data 58b.

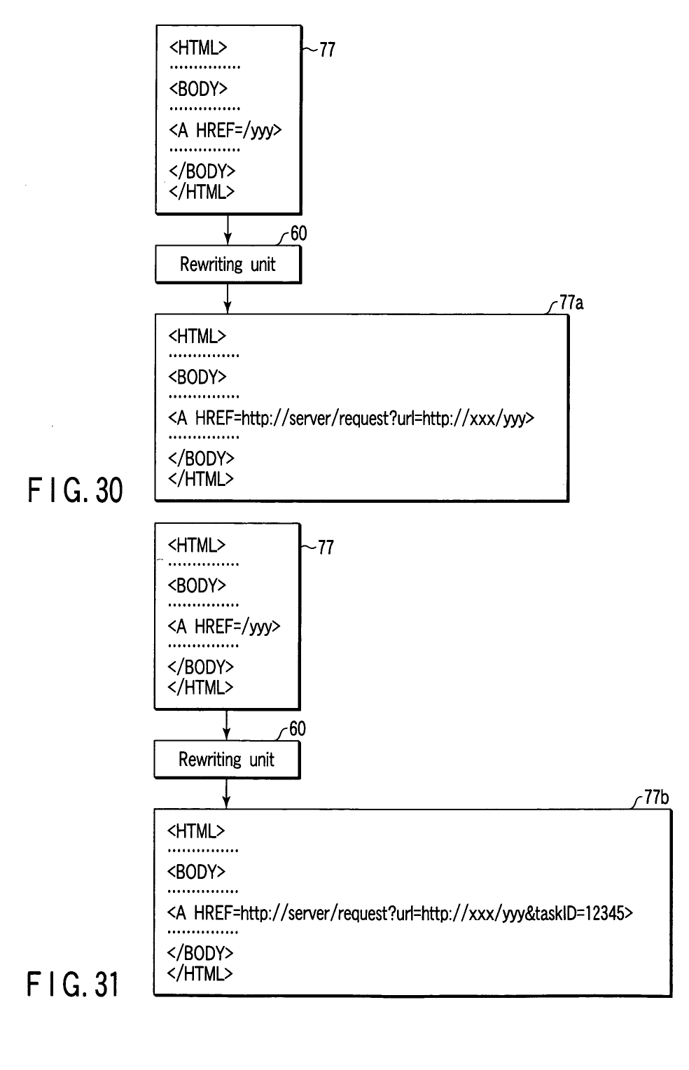

FIG. 30 is a block diagram depicting a first conversion example of execution data provided from a service to a Web browser. In FIG. 30, the seamless system 50 indicates a case of a name “server”.

The rewriting unit 60 extracts hyper link “/yyy” included in a <A> tag of execution data 77 before converted, the execution data being provided from a service, and identifies host name “xxx” for providing a service indicated by the hyper link “/yyy”. In the execution data 77 before converted, hyper link information is specified by specifying “href”.

Next, the rewriting unit 60 rewrites the contents of the <A> tag included in the execution data 77 before converted into <A HREF=http://server/request?url=http://xxx/yyy>, based on the host name “xxx” identified as URL “http://server/request” for notifying a request to the seamless system 50 and the extracted hyper link “/yyy”, and produces execution data 77a after rewritten,

This execution data 77a after rewritten is sent to a terminal via the optimizing unit 8 and terminal connecting unit 6. When a user utilizing the terminal makes a request for utilizing a service desired to be utilized next by clicking a hyper link included in the execution data 77a after rewritten, such a request is notified to the seamless system 50. This is because original hyper link information is rewritten so that a request is notified to the seamless system. If execution data is sent to a terminal without rewriting hyper link information, when the terminal clicks the hyper link included in the execution data, the request is notified to host “xxx”, instead of being notified to the seamless system 50. Thus, the data indicating a service utilization state cannot be acquired by the seamless system 50.

In the above-described example, a portion “http://server/request” corresponds to link information for the seamless system 50. Namely, the current information is rewritten into address information including link information of the seamless system 50 itself (one's own) based on address information (“/yyy” in the above example) on another process included in the contents. In the case where the host name “xxx” is identified, when a request corresponding to execution data is made from a device to the seamless system 50, such a request includes information “http://server//request?url=http://xxx/ooo”, and thus, this URL information is temporarily stored (by a memory or the like). Then, when the hyper link “/yyy” is extracted from execution data, the host name “xxx” for providing a service indicated by the hyper link “/yyy” is identified from the URL information.

FIG. 31 is a block diagram depicting a second conversion example of execution data provided from a service to a Web browser.

The rewriting unit 60 extracts the hyper link “/yyy” included in the <A> tag of the execution data 77 before converted, the data being provided from a service, and identifies the host name “xxx” and the work ID “1234” which provide a service indicated by the hyper link “/yyy”.

Next, the rewriting unit 60 rewrites the contents of the <A> tag included in the execution data 77 before converted into <A HREF=http://server/request?url=http://xxx/yyy&taskid=12 345>, based on the host name “xxx” identifies as URL “http://server/request” for notifying a request to the seamless system 50 and the work ID (task ID) “12345” identified as the hyper link “/yyy”, and produced execution data 77b after rewritten.

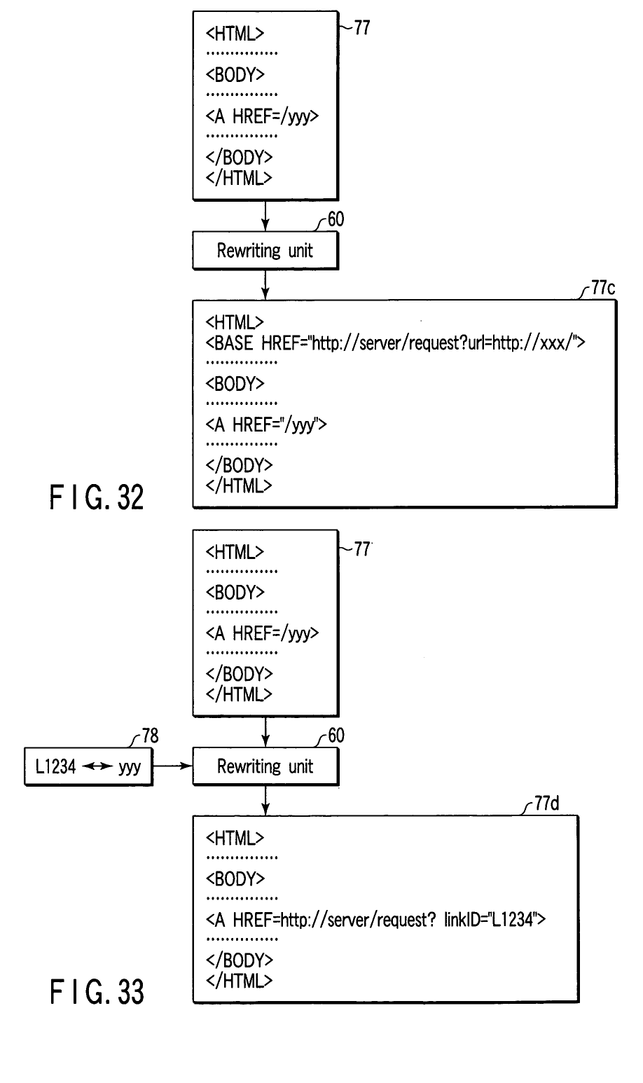

FIG. 32 is a block diagram depicting a third conversion example of execution data provided from a service to a Web browser.

The rewriting unit 60 additionally enters a <BASE> tag for integrally specifying a basic portion of URL contained in the execution data 77 in the execution data 77.

In this manner, even if the contents of each <A> tag contained in the execution data 77 before converted, the execution data being provided from a service, is not rewritten, a hyper link contained in the execution data 77 can be converted so as to provide an access to a service via the seamless system 50.

FIG. 33 is a block diagram depicting a fourth conversion example of execution data provided from a service to a Web browser.

The rewriting unit 60 extracts the hyper link “/yyy” included in the <A> tag of the execution data 77 before converted, and converts into a link ID “L1234” the hyper link “/yyy” extracted based on data 78 obtained by associating a link ID with the hyper link. In the present embodiment, the data 78 is recorded in the recording unit 5, and can be accessed via the data managing unit 57.

Next, the rewriting unit 60 rewrites the contents of the <A> tag included in the execution data 77 before converted into <A HREF=http://server/request?linkid=L1234> based on URL “http://server/request” for notifying a request to the seamless system 5 and the link ID “L1234”0, and produces execution data 77d after rewritten.

After the execution data 77d after rewritten has been sent to a terminal, in the case where a new service utilization request has been made by the user clicking a hyper link, the service managing unit 59 having received the link ID from the terminal via the terminal connecting unit 55 converts the link ID into URL based on the data 78, and makes a request to a service indicated by this URL.

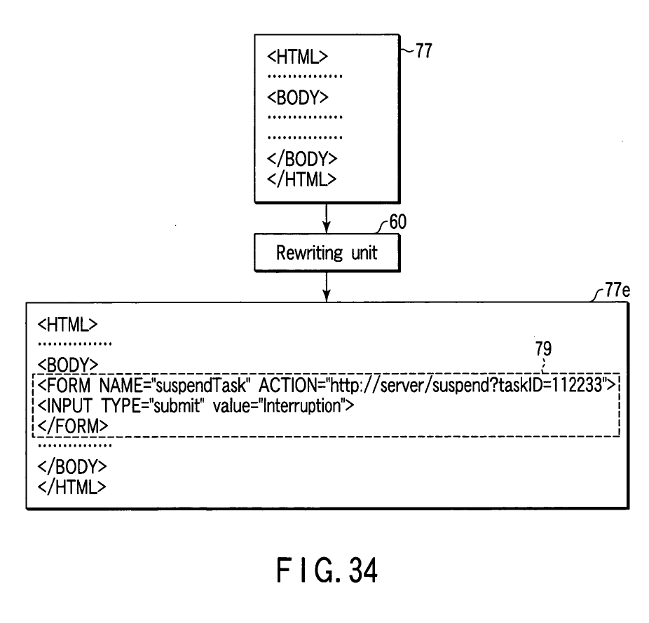

FIG. 34 is a block diagram depicting a fifth conversion example of execution data provided from a service to a Web browser.

The rewriting unit 60 embeds a hyper link 79 for making an interrupting request in the execution data 77 before converted, and produces execution data 77e after rewritten.

In addition, a work ID is added to the hyper link 79 in order to record work continuity. In the case where the user carries out a plurality of works (for example, a tour reservation work and a tour sightseeing information acquisition work) in parallel with each other, the work ID added rewriting is particularly effective to identify the plurality of works.

A suspend task function for making an interrupting request is incorporated in the execution data 77e. When an interrupt button is pressed, the browser displaying the execution data 77e provides to the seamless system 50 a request for interrupting a work indicated by a work ID “112233”.

By such a processing of the rewriting unit 60, a request and execution data are transmitted and received between a service and a terminal via the seamless system 50.

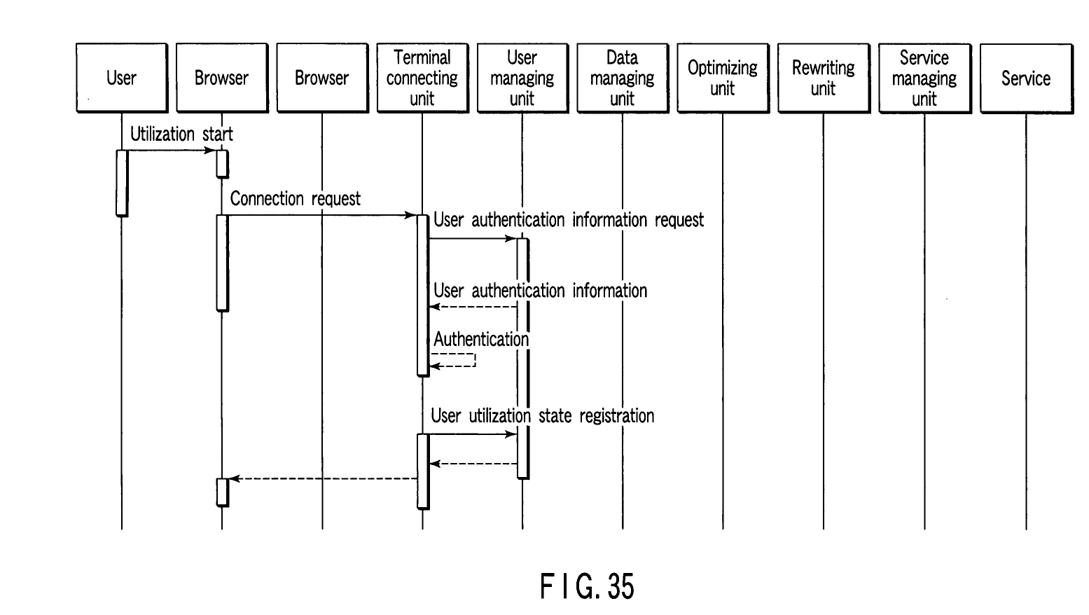

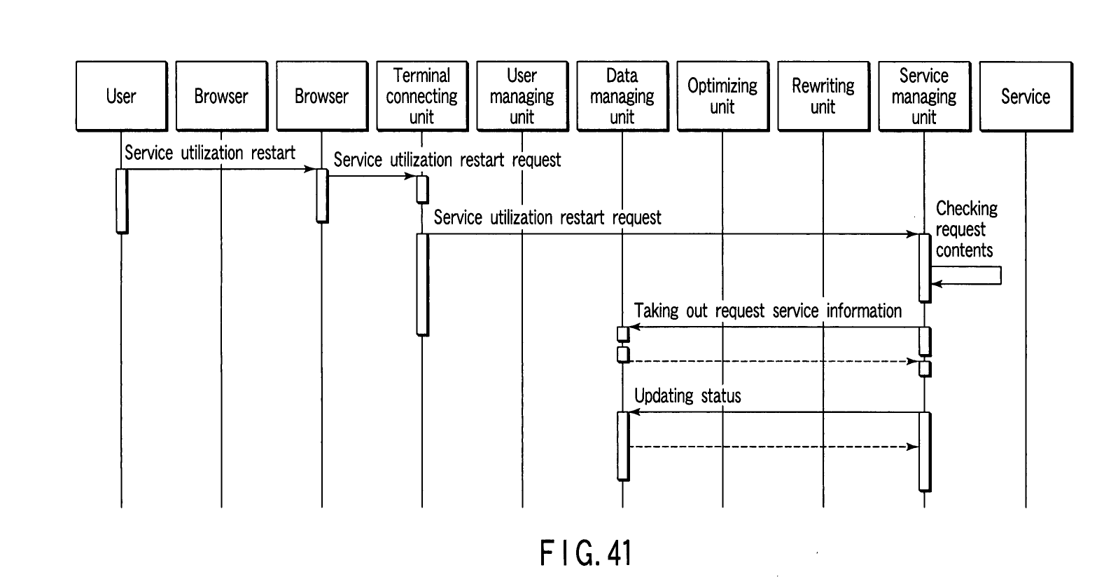

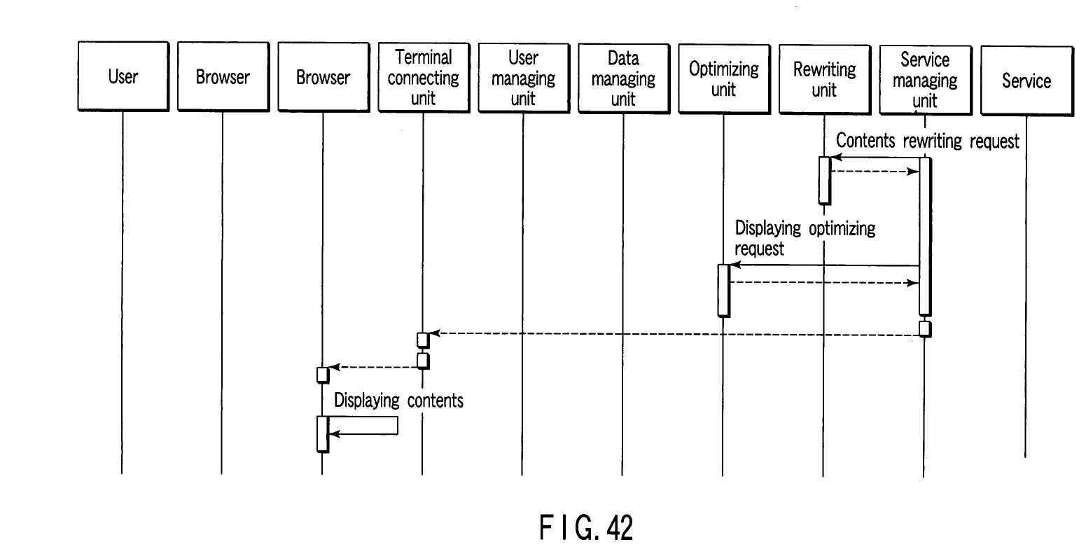

An operation of the seamless system 50 as described above will be described with reference to FIGS. 35 to 42. FIGS. 35 to 42 each represent a series of operation to be continued along a time series.

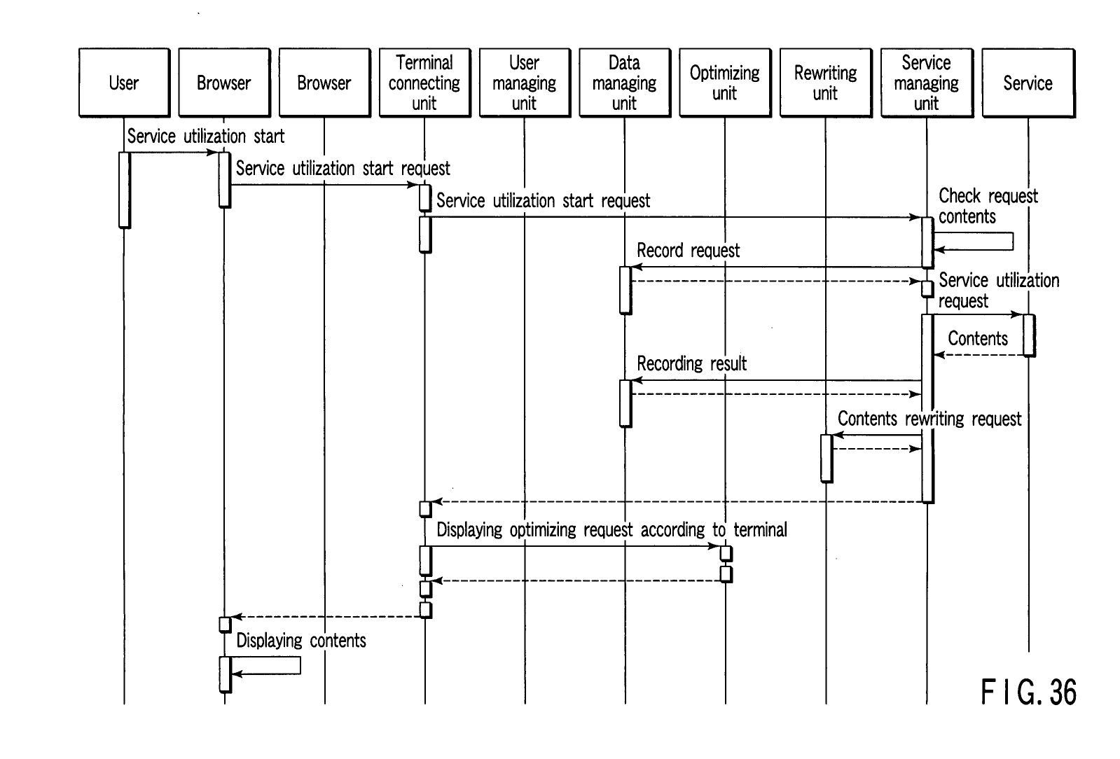

FIGS. 35 and 36 are sequence views each showing an operation from a user requesting service utilization start to display of contents.

First, the user starts utilization of a terminal, and operates the terminal to make connection to the seamless system 50. For example, URL (address) representing a seamless service provided by the seamless system 50 is specified by the user; a connection to this specified address is requested; and connection to the seamless system 50 is made.

The terminal connecting unit 55 having received a connection request authenticates a user who makes user authentication and makes a connection request.

A variety of techniques can be utilized for a method for user authentication. For example, the terminal connecting unit 55 completes authentication if the user ID and password accepted from the terminal during the connection request matches the user ID and password of the user management data 58a managed by the user managing unit 56. In addition, the terminal connecting unit 55 may makes user authentication by using an electronic certificate.

Next, the terminal connecting unit 55 registers information that the user enters a utilization start state in the user management data 58a by using the user managing unit 57.

After connection has completed, the user operates a terminal; specifies a desired service; and provides the service utilization start request to the seamless system 50.

The service utilization start request is provided to the service managing unit 59 via the terminal connecting unit 55.

The service managing unit 59 checks the contents of the request accepted from the terminal.

When the accepted request is a service start request, the service managing unit 59 takes out service identification data on the service specified as a start object. The URL of a network service is used, for example, as service identification data. In addition, instead of URL, a specific ID managed by the seamless system 50 in order to specify a service may be used as the service identification data.

Next, the service managing unit 59 calls the data managing unit 57, and records information indicating a request from a terminal in the state management data 58b. URL is used as the information indicating the request from the terminal, for example. Alternatively, HTTP request data sent from the terminal to the seamless system 50 may be used. Alternatively, upon the receipt of the request from the terminal, the HTTP request data sent may be used when the seamless system 50 calls a service of the network service group 4.

The service managing unit 59 requests a service to a network service server or a local service server which provides a service based on service identification data on a service targeted for call, the service being specified from the terminal.

For example, when the service identification data is URL in which an HTTP protocol has been specified, the service managing unit 59 makes an HTTP request to an HTTP server. Then, the service managing unit 59 accepts contents as a response of that request, and records the contents in state management data 58b by using the data managing unit 57. Further, the service managing unit 59 records a utilization state or the like in the state management data 58b by using the data managing unit 57. For example, information indicating start of a service specified from a terminal is recorded in the state management data 58b.

Next, the rewriting unit 60 carries out a rewriting process for embedding information associated with interruption and restart in contents.

For example, when the user clicks a hyper link in contents, in order for the seamless system 50 to provide an interrupting and restarting function, there is a need for the seamless system 50 to be called at a time point at which the user clicks the hyper link.

Therefore, the hyper link contained in the contents is rewritten, and rewriting of the hyper link is carried out so as to call the hyper link specified in source contents via the seamless system 50.

That is, the rewriting unit 60 rewrites the hyper link contained in the contents provided to the terminal so that the service providing side is accessed from the user operated terminal via the seamless system 50.

The terminal connecting unit 55 accepts the contents after rewritten from the rewriting unit 60. In addition, the terminal connecting unit 55 calls the optimizing unit 8, and converts the contents after the hyper link has been rewritten in a mode according to a terminal display function or an input function. Then, the terminal connecting unit 55 provides the contents after converted to the terminal.

The provided contents are displayed on the terminal.

The user makes an operation for display of the contents, and occasionally, requests a next screen.

A variety of methods are considered as means for implementing the optimizing unit 8. For example, it is possible to utilize a trans-coding middleware or the like as the optimizing unit 8.

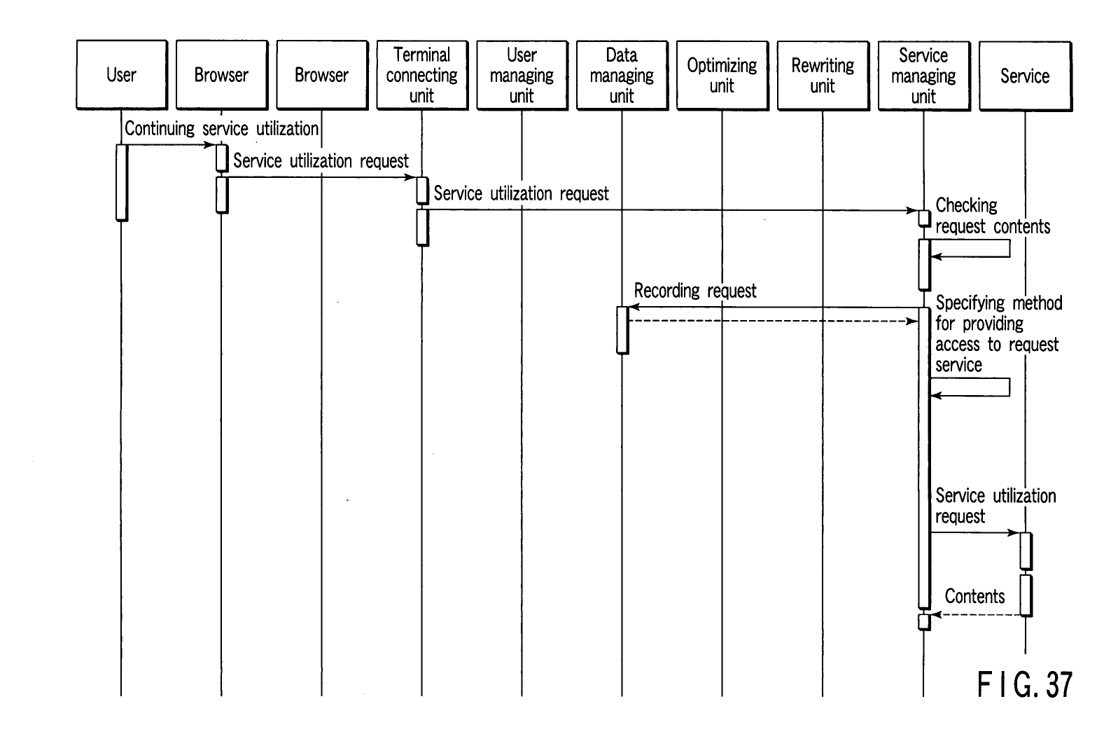

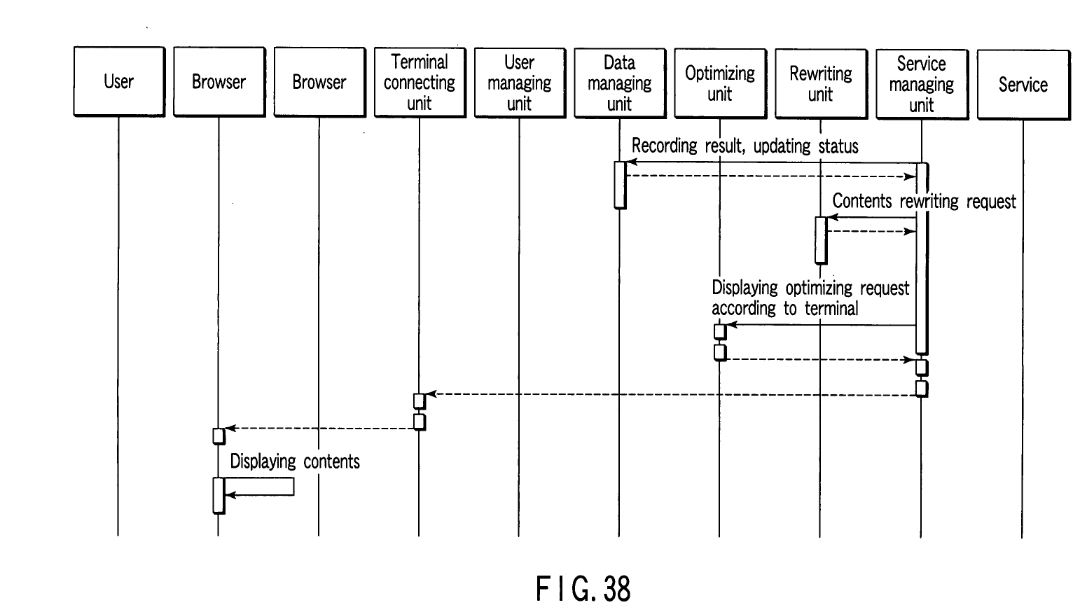

FIGS. 37 and 38 are sequence charts each showing an operation in the case where a service has been called after contents has been displayed. An operation from clicking of the hyper link contained in the provided contents to call of the next contents (HTML page) correspond to that of FIGS. 37 and 38.

The contents displayed on the terminal are provided as contents rewritten by the rewriting unit 60. Therefore, the hyper link to be next clicked by the user is not a link described in source contents, but a link processed so as to pass through the seamless system 50. Therefore, the user requests continuing service utilization to the seamless system 50 merely by clicking the hyper link in the same manner as in the case of utilizing a network service provided by a general HTTP server. In this manner, the seamless system 50 relays exchange between the terminal and the network service, making it possible to acquire information for interrupting and restarting the user utilized service at a time point of relay.

First, the user clicks a hyper link. Then, a service utilization request is provided from the terminal to the terminal connecting unit 55. The service utilization start request is provided to the service managing unit 59 via the terminal connecting unit 55.

The service managing unit 59 checks the contents of a request accepted from the terminal.

When the request accepted from the terminal is a service utilization request, the service managing unit 59 takes out service identification data. The service identification data taken out at this time point is provided as information rewritten by the rewriting unit 60 at a previous call. The taken-out service identification data is provided as information capable of specifying URL specified in the source contents.

Next, the service managing unit 59 calls the data managing unit 57, and records a request from a terminal.

In FIGS. 37 and 38, the subsequent processing is similar to that in the case of FIGS. 35 and 36 described above. That is, a request is provided from the service managing unit 59 to the network service server or local service server for providing a service; processing such as recording contents or rewriting contents is carried out; and then, the processed contents are provided to the terminal.

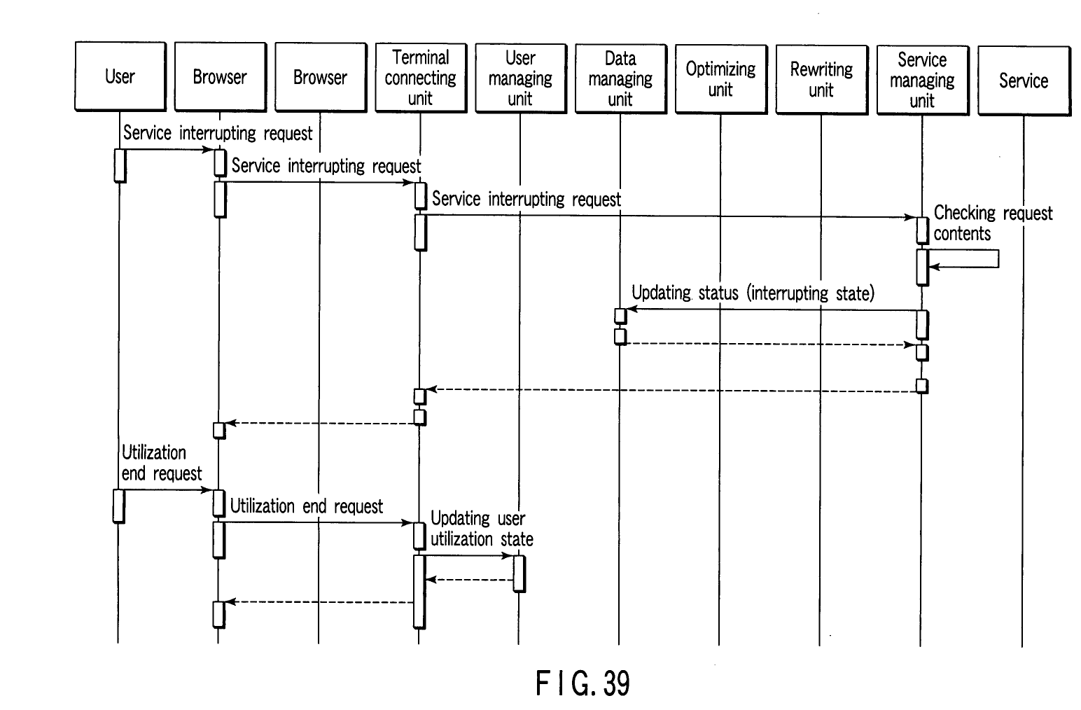

FIG. 39 is a sequence chart showing an operation in the case where a service is interrupted from the above state of FIG. 38.

The user provides a service interrupting request to the seamless system 50 at a time point at which the service is interrupted.

A service interrupting request is provided to the service managing unit 59 via the terminal connecting unit 55. The service managing unit 59 checks the contents of the request provided from the terminal. In the case where a request is a service interrupting request, the service managing unit 59 set a service status of the state management data 58b at an interrupting state by using the data managing unit 57. For example, the service managing unit 59 changes a currently used state to an interrupting state. Alternatively, a service ID is included in an interrupting request from the user, and the service managing unit 59 sets the service status corresponding to the service ID of the interrupting request at an interrupting state.

Then, the user provides a utilization end request to the seamless system 50.

The utilization end request is provided to the service managing unit 59 via the terminal connecting unit 55. The service managing unit 59 checks the contents of the request provided from the terminal. When a request is a utilization end request, the service managing unit 59 updates a system status of the user management data 58a to an end state, and terminates service utilization by using the user managing unit 56.

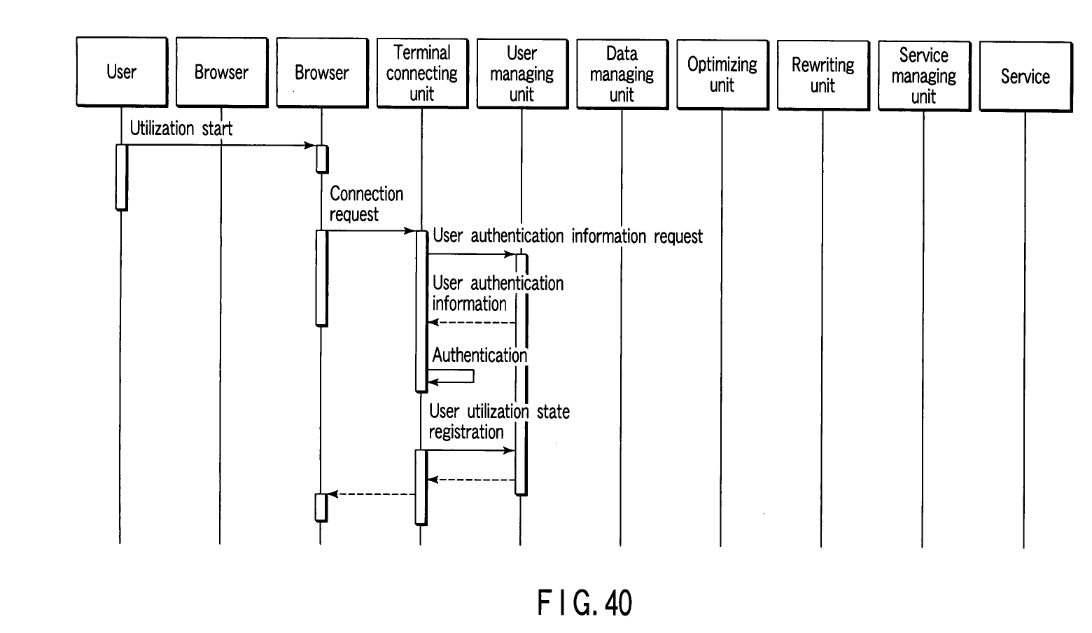

FIGS. 40 to 42 are sequence charts each showing an operation for restarting utilization of the service interrupted in the operation from FIGS. 35 to 39 from another terminal.

First, the user provides a connection request to the seamless system 50 by using a terminal other than the terminal used from FIGS. 35 to 39. Then, the user authenticating process is carried out in the same manner as in the case of FIG. 35.

Next, restarting of the service being interrupted is requested by the user. For example, the service managing unit 59 selects the service being interrupted after the user authentication, and includes a list of services being interrupted on a screen returned from the seamless system 50 to the terminal. The user operated terminal displays a list of services being interrupted, and obtains restarting of utilization with respect to the user selected service from among the listed services.

The service utilization restart request is provided from the terminal to the service managing unit 59 via the terminal connecting unit 55.

The service managing unit 59 acquires state management data 58b relating to an execution state of service by using the data managing unit 57, and checks the contents of the request accepted from the terminal.

When the accepted request is a service restart request, the service managing unit 59 first takes out information on service targeted to be restarted. A method for specifying the service targeted to be restarted includes a method for including the service identification data for specifying a service and a method for restarting a service of an interrupting status by handling it as a restart target.

Next, the service managing unit 59 executes a restart processing based on the taken-out information of the service targeted to be restarted.

First, the service managing unit 59 updates a service status of a service targeted to be restarted in the state management data 58b by using the data managing unit 57 because service utilization has been restarted.

The service managing unit 59 executes a restarting process. For example, the service managing unit 59 records the whole contents obtained from a network service before interruption (the whole HTTP response obtained from the network service); rewrites the contents recorded during restarting by the rewriting unit 60; carries out display optimization according to the terminal by means of the optimizing unit 8; and then, provides the optimized contents to the terminal.

In addition, for example, the service managing unit 59 records the HTTP request provided to the network service before interruption; provides the HTTP request recorded during restarting to the network service; acquires the recorded request from the network service; rewrites and optimized the acquired contents; and then, provides the resulting contents to the terminal.

As has been described above, in the present embodiment, after a work of one terminal has been interrupted, in the case where the work is restarted on another terminal, a state immediately before interrupted on a terminal restarting a work can be simulated. That is, the service can be interrupted and restarted between a plurality of terminals comprising a Web browser.

In addition, in the present embodiment, the work which has been carried out on one terminal can be restarted on another terminal without adding a specific component other than the Web browser which is generally distributed as a terminal side environment. In addition, the work can be restarted after temporary interruption with an elapse of time on the same terminal. Therefore, the user can receive a seamless service by the seamless system 50 easily and speedily.

In addition, that function can be utilized in association with various types of terminals such as a personal computer, a PDA, and a hand held cellular phone, and can be utilized even if an OS (Operating System) is different from another one.

(Sixth Embodiment)

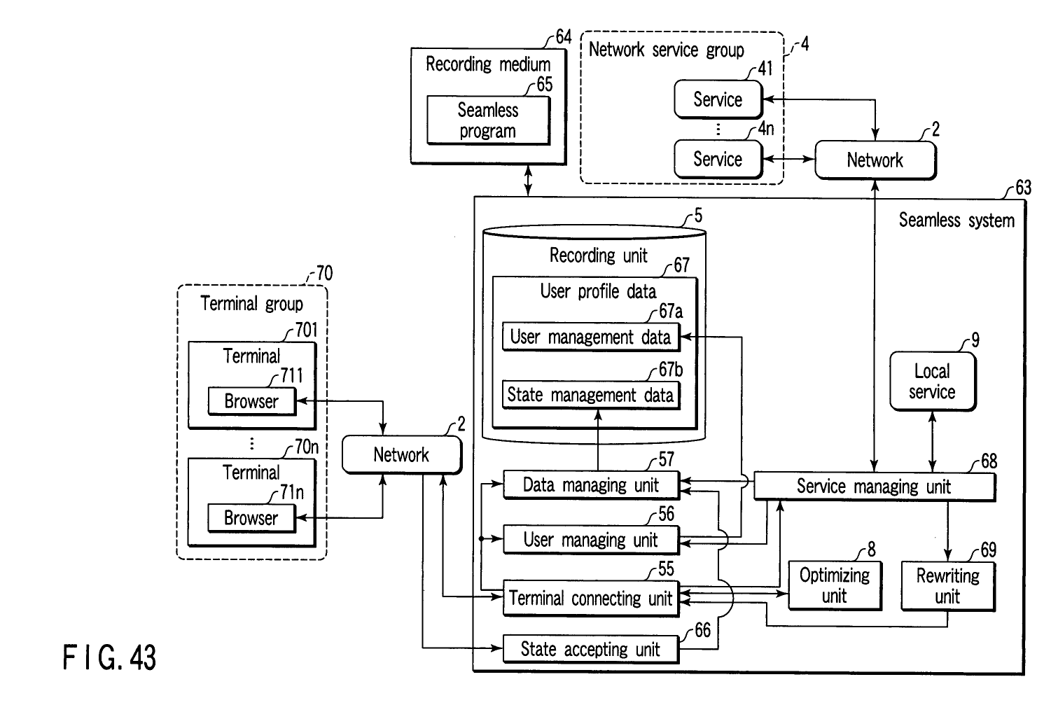

FIG. 43 is a block diagram depicting an example of a configuration of a seamless system according to the present embodiment.

A recording unit 5 which a seamless system 63 comprises records user file data 58 including user management data 67a and state management data 67b.

The seamless system 63 reads and executes a seamless program 65 recorded in a recording medium 64, thereby achieving functions as a terminal connecting unit 55, a state accepting unit 66, a user managing unit 56, a data managing unit 57, a service managing unit 68, an adding unit 69, and an optimizing unit 8.

Terminals 701 to 70n of a terminal group 70 are connected to the seamless system 63 via a network 2. The terminal 701 to 70n comprises browsers 711 to 71n, respectively.

The browsers 711 to 71n are generally distributed browsers, and may be browsers installed in a commercially available personal computer, for example.

The generally distributed browsers each comprises: a function for setting a proxy server; a client script function; a function for notifying a server of information from a client by utilizing the client side script; and a function for notifying an access destination of a hyper click event during hyper link clicking, and uploading information to the access destination.

When an access is provided from a terminal to the seamless system 63, setting of the proxy server function is provided in the browsers 711 to 71n, and the seamless system 63 is set as a proxy server. Then, all the requests from the browsers 711 to 71n specifying URL of a network service or a local service are automatically provided to the seamless system 63 by means of functions which the browsers 711 to 71n.

In the present embodiment, exchange between a terminal and a network service is relayed by the seamless system 63 by utilizing the browser proxy server function.

The adding unit 69 carries out a process for embedding in contents a state notifying script for the seamless system 63 to acquire the terminal browser utilization state. Here, the state notifying script is provided as a script for providing a terminal state to the seamless system 63 by using a client side script function which the browser comprises and an information notifying function from the client utilizing the client side script to a server.

By embedding the state notifying script in contents (by the seamless system 63 embedding a command for notifying device state information in one's own system), in the case where a hyper link is clicked by the user in the browser, and a browser display target is changed from a page displayed during clicking to another page, or alternatively, in the case where a window is closed by a function for closing the browser window, state information indicating that one page has been changed to another or that the window has been closed is provided from the terminal to the seamless system 63.

The state accepting unit 66 accepts state information provided to the seamless system 63 in the case where the state notifying script added in the adding unit 69 has been called such as when the hyper link has been clicked in the browser, for example, or when the window has been closed. The state accepting unit 66 records the state information as a service status in state management data 67b by using the data managing unit 57.

The seamless system 63 having the configuration as described above relays all requests between a terminal and a network service. Thus, the user can recognize which page has been provided to the terminal side. All of these requests are recorded in the state management data 58b as URL in FIG. 26 (corresponding to processing identification data).

In addition, the seamless system 63 embeds a state notifying script in contents at the adding unit 69, whereby the seamless system can accept and recognize from the terminal side a lost page which has not been displayed by the window closing at the terminal side or by one page changing to another page.

Then, the seamless system 63 takes a difference between all the pages provided to the terminal and the lost pages, thereby making it possible to recognize which page is displayed on a terminal.

The service managing unit 68 determines which page has been displayed at the end of the user terminal utilization by means of an interrupting function, and records the determined page. In addition, the service managing unit 68 redisplays the page determined to have been interrupted by the restart function during restarting.

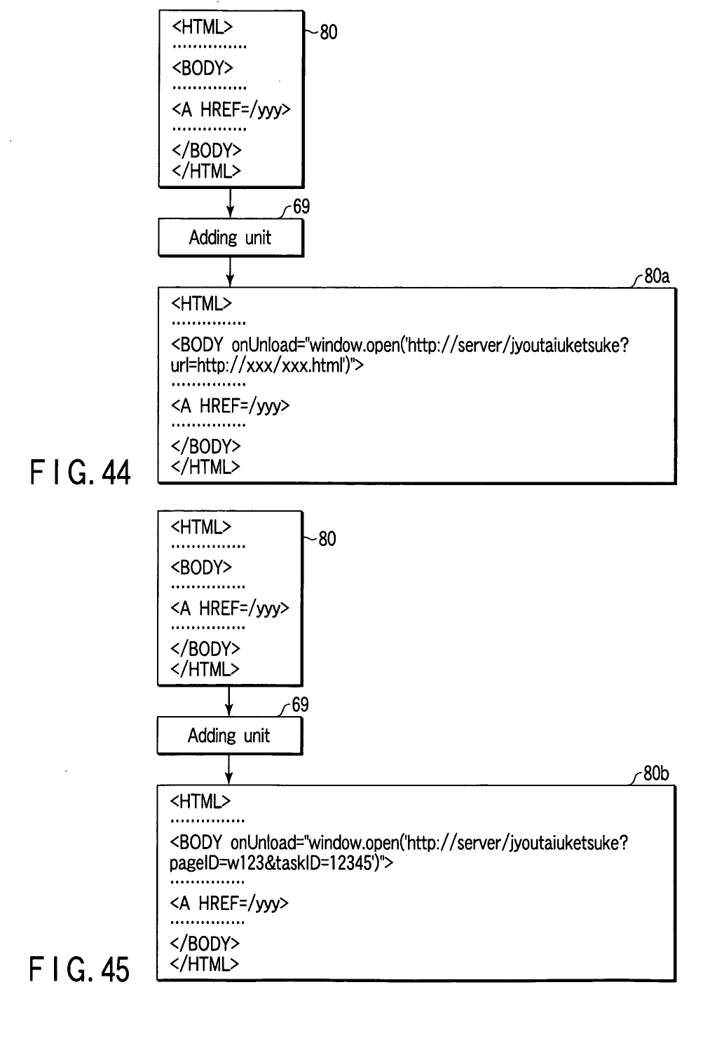

FIG. 44 is a block diagram depicting a first conversion example of result data provided from a service to a Web browser.

The adding unit 69 accepts page 80 of URL “http://xxx/xxx.html”.

Then, when this page has been changed or in the case where the page has been closed, the adding unit 69 accesses the state accepting unit 66 of the seamless system 63 and adds to page of URL “http://xxx/xxx.html” a state notifying script which includes a command for providing URL “http://xxx/xxx.html” from the terminal to the state accepting unit 66.

Then, page 80a after added is provided to the terminal. “window.open('http://server/jyoutaiuketuke?url=htt p://xxx/xxx.html') described on page 80a after added is provided as a command for reading out URL “/server/jyoutaiuketuke” when this page 80a is lost from the browser and notifying URL “/xxx/xxx.html” indicating this lost page.

FIG. 45 is a block diagram depicting a second conversion example of result data provided from a service to a Web browser.

In the case where page 80 of URL “http://xxx/xxx.html” has been changed or in the case where the page has been closed, the adding unit 69 accesses the state accepting portion 66 of the seamless system 63; adds to page 80 of URL “http://xxx/xxx.html” a state notifying script including a command for providing a page ID indicated by this page from the terminal to the state accepting unit 66; and produce page 80b after added. The seamless system 63 can recognize which page has been changed or closed from the accepted page ID.

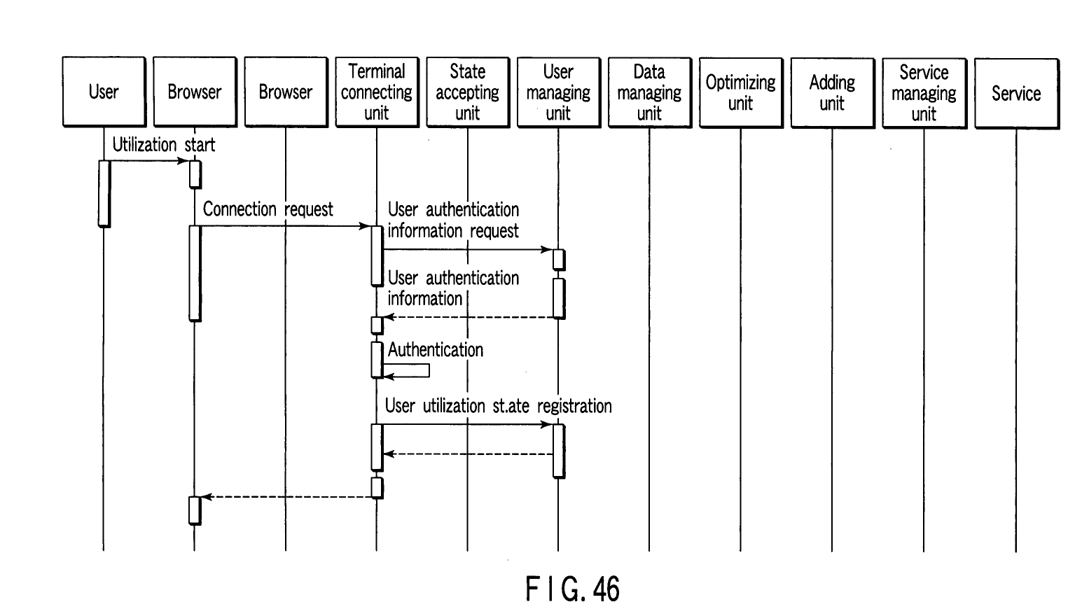

An operation of the seamless system 63 as described above is presented in FIGS. 46 to 52. FIGS. 46 to 52 each present a series of operations which continue along a time series.

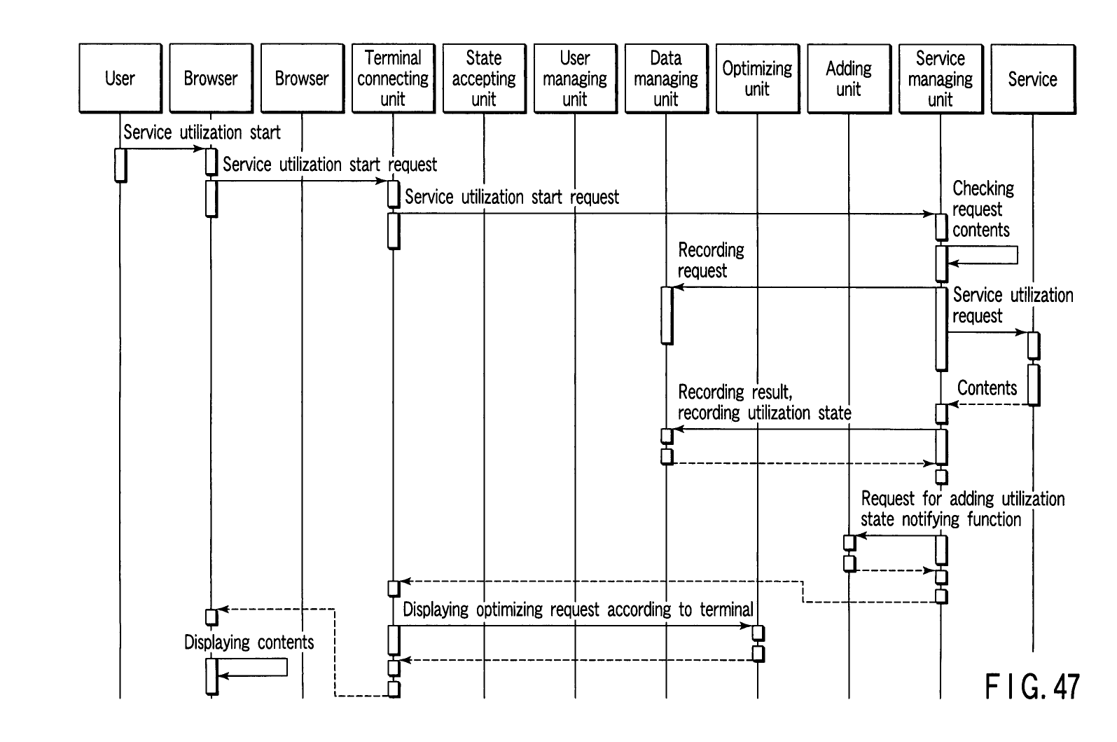

FIGS. 46 and 47 are sequence charts each showing an operation from the user requesting service utilization start to display of the contents.

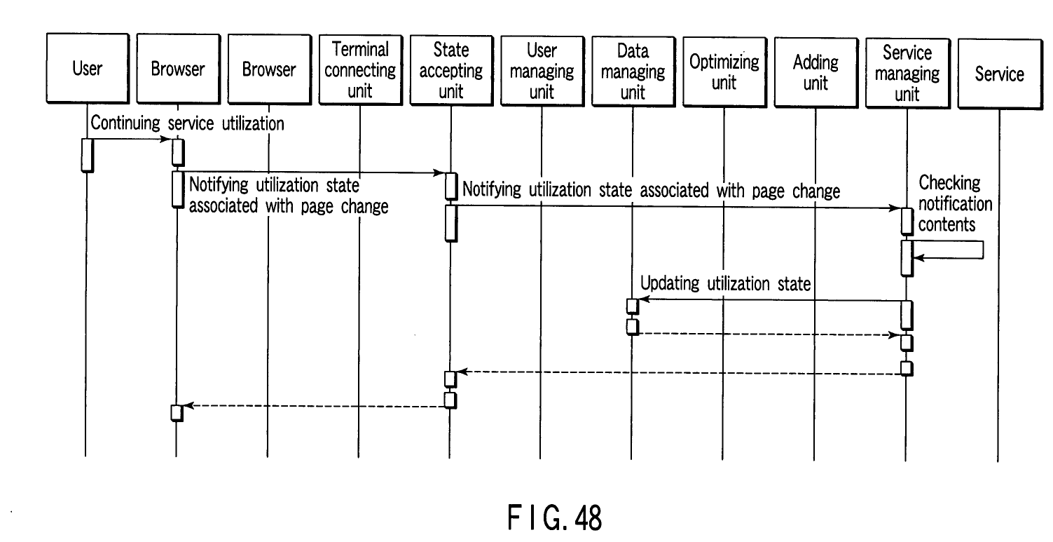

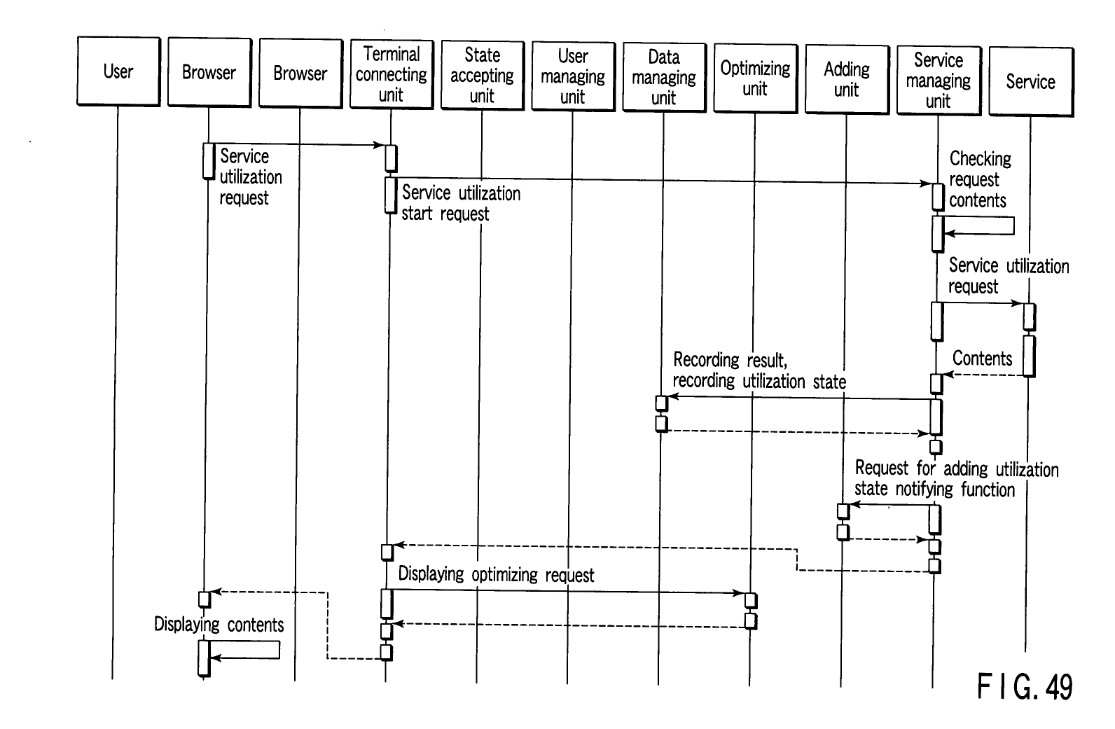

FIGS. 48 and 49 are sequence charts each showing an operation from continuous service call after displaying contents to display of contents in response to this call.

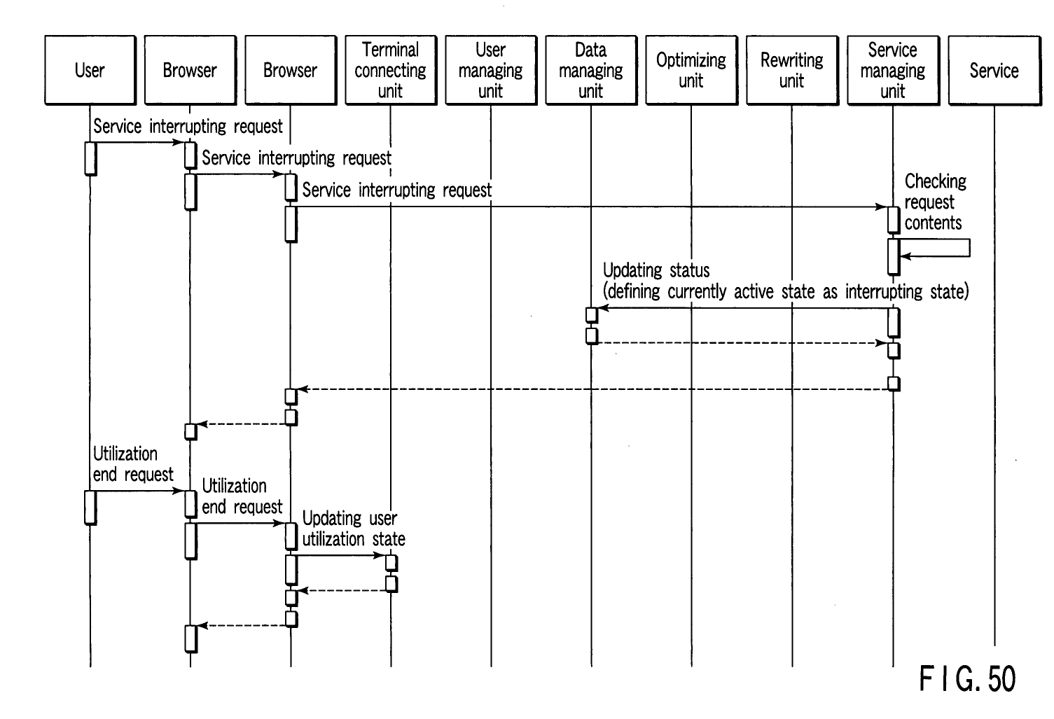

FIG. 50 is a sequence chart showing an operation in the case where a work is interrupted from the above state of FIG. 49.

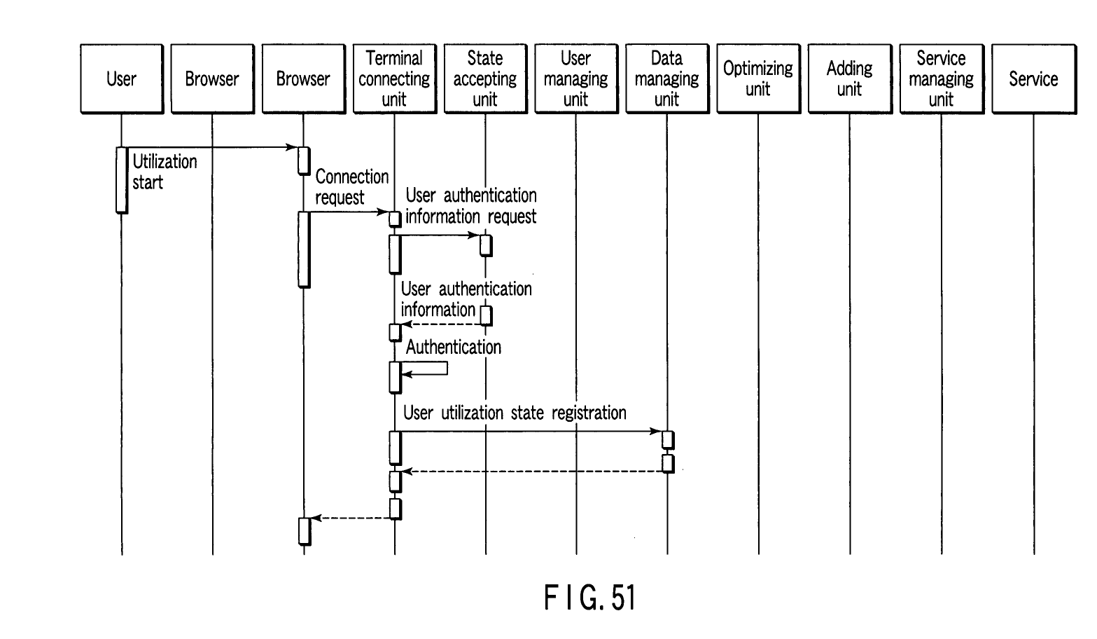

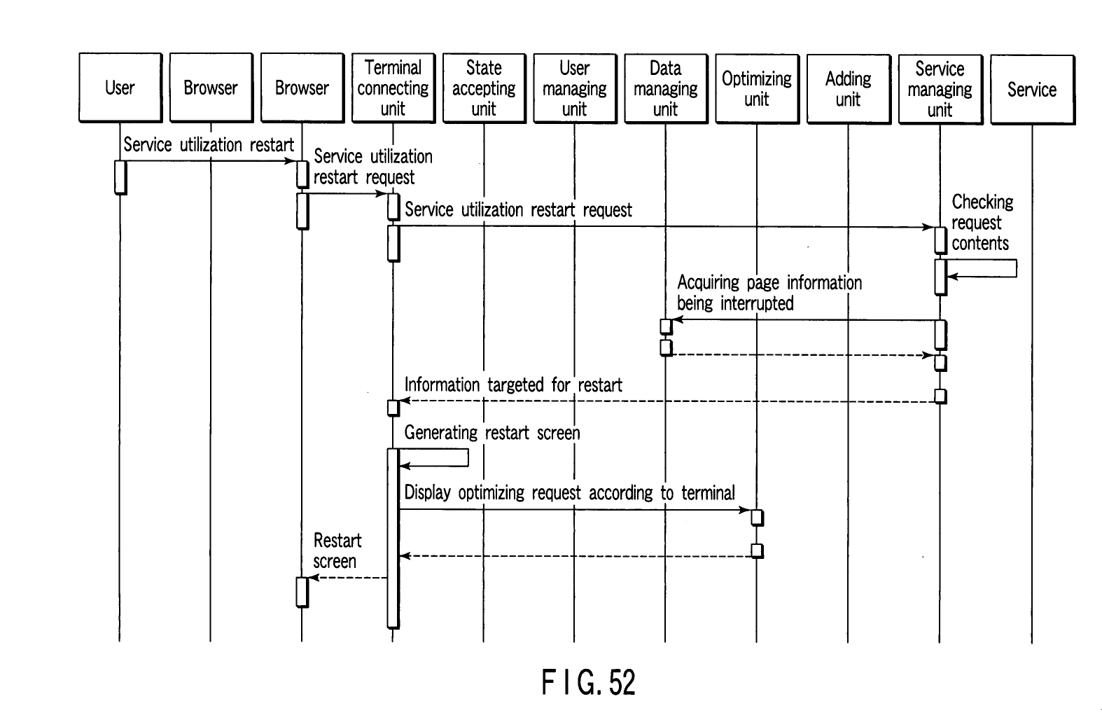

FIGS. 51 and 52 are sequence charts each showing an operation for restarting utilization of the service interrupted in the above operation from FIGS. 46 to 50 from another terminal.

In the present embodiment, unlike the case of above fifth embodiment, there is an advantage that all the hyper links on page may not be rewritten.

For example, there is a case in which a hyper link is dynamically generated at the terminal side by using a client side script. In such a case, it is difficult to rewrite a hyper link of page in advance so as to pass through the seamless system and to provide the rewritten hyper link to a terminal. However, in the present embodiment, all the accesses from the terminal are provided via the seamless system 63 by means of the browser proxy server setting function. Therefore, even if a hyper link is dynamically generated at the terminal side, the seamless service by the seamless system 63 can be provided.

In addition, in the present embodiment, even in the case of using a browser which has a function for displaying a plurality of pages in a plurality of windows, the seamless system 63 recognizes a state of each window, and provide a seamless service. Thus, the states of a plurality of windows can be interrupted and restarted.

(Seventh Embodiment)

In this embodiment, a description will be briefly given with respect to a seamless system using a combination of the seamless system 50 according to the fifth embodiment described above and the seamless system 63 according to the sixth embodiment described above.

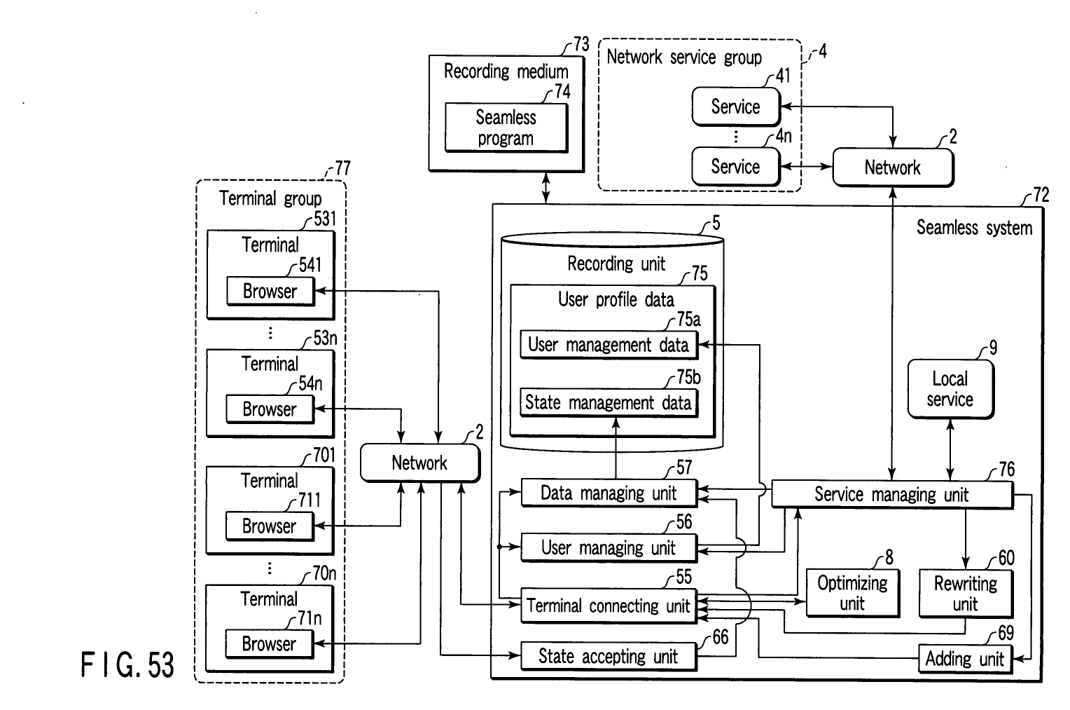

FIG. 53 is a block diagram depicting an example of a configuration of a seamless system according to the present embodiment.

A seamless system 72 not only comprises both of the functions of the seamless system 50 according to the fifth embodiment described above and the seamless system 63 according to the sixth embodiment described above independently, but makes managed data identical to each other.

Thus, a user starts a work in accordance with an operation corresponding to the fifth embodiment described above by using a hand held cellular phone or the like, for example; temporarily interrupts this work; and then, restart the work in accordance with an operation corresponding to the sixth embodiment described above by using a desk top type personal computer.

That is, for example, like a hand held cellular phone or the like, in the case where a terminal does not comprise: a proxy server setting function; a client side script function; an information notifying function from a client to a server utilizing the client side script, a seamless service can be provided by the operation corresponding to the fifth embodiment described above.

On the other hand, like a personal computer or the like, in the case where a terminal comprises: a proxy server setting function; a client side script function; an information notifying function from a client to a server utilizing the client side script, a seamless service which can be interrupted and restarted for a hyper link dynamically generated page in accordance with the operation corresponding to the sixth embodiment described above.

1. A seamless system comprising:
a managing unit which manages utilization state data obtained by associating user identification data accepted from a device with processing identification data indicating a process requested to be executed from the device;
a storage unit which registers in the utilization state data, restart achievement data to be used to achieve restarting of the process indicated by the processing identification data; and
a restarting unit which, when a restart request and the user identification data have been accepted, acquires the processing identification data and the restart achievement data corresponding to the user identification data based on the utilization state data, and provides to an originating device making the restart request an execution result of the process indicated by the processing identification data obtained based on the restart achievement data.

2. A seamless system according to claim 1, wherein
the restart achievement data includes data indicating a restart point for restarting the process, and
the restarting unit provides to the originating device making the restart request the execution result of the process at and after the restart point.

3. A seamless system according to claim 1, wherein
the restart achievement data includes attribute data used both the device and the process, and
the restarting unit uses the attribute data to change over from a relationship between the originating device making the restart request and the process to a relationship between the device before an interrupt event occurs in the device and the process.

4. A seamless system according to claim 1, wherein,
when an interrupt event occurs in the device, the storage unit registers state data indicating that the process has been interrupted in the utilization state data, and
when the restart request and the user identification data have been accepted after the occurrence of the interrupt event, the restarting unit acquires restart achievement data for restart and processing identification data for restart indicating interruption by the state data in association with the user identification data from among the utilization state data, and provides to an originating device making the restart request an execution result of a process indicated by the processing identification data for restart obtained based on the restart achievement data for restart.

5. A seamless system according to claim 1, further comprising an optimizing unit which converts into a format of a providing destination a format of contents accepted from at least one of the device, the originating device making the restart request, and the process.

6. A seamless system comprising:
a managing unit which manages utilization state data obtained by associating user identification data accepted from a device with processing identification data indicating a process requested to be executed from the device; and
a restarting unit which, when a restart request and the user identification data have been accepted, acquires the processing identification data corresponding to the user identification data based on the utilization state data, and provides to an originating device making the restart request an execution result of the process indicated by the processing identification data.

7. A seamless system comprising:
a managing unit which manages utilization state data obtained by associating user identification data accepted from a device with processing identification data indicating a process requested to be executed from the device;
a storage unit which, when an interrupt event has occurred in the device, registers in the utilization state data, state data indicating that the process indicated by the processing identification data has been interrupted; and
a restarting unit which, when a restart request and the user identification data have been accepted, acquires processing identification data for restart indicating interruption by the state data in association with the user identification data from among the utilization state data, and provides to an originating device making the restart request an execution result of the process indicated by the processing identification data for restart.

8. A seamless system comprising:
a managing unit which registers user identification data accepted from a device in utilization state data;
a storage unit which registers restart achievement data to be used to achieve restarting of a predetermined process in the utilization state data in association with the user identification data; and
a restarting unit which, when a restart request and the user identification data have been accepted, acquires the restart achievement data in association with the user identification data based on the utilization state data, and provides to an originating device making the restart request an execution result of the process obtained based on the restart achievement data.

9. A seamless system according to claim 8, wherein
the restart achievement data includes data indicating a restart point for restarting the process, and
the restarting unit provides an originating device making the restart request an execution result of the process at and after the restart point.

10. A seamless system according to claim 8, wherein
the restart achievement data includes attribute data used both the device and the process, and
the restarting unit uses the attribute data to change over from a relationship between the originating device making the restart request and the process to a relationship between the device before an interrupt event occurs in the device and the process.

11. A seamless system, comprising:
a managing unit which manages utilization state data obtained by associating user identification data accepted from a device with processing identification data indicating a process requested to be executed from the device; and
a rewriting unit which, when address information on another process is included in contents provided to the device, rewrites the address information into address information including link information on one's own system based on the address information, wherein
the managing unit stores received information as the utilization state data when receiving the processing identification data based on the address information rewritten by the rewriting unit, and restarts a process corresponding to the user identification data based on the utilization state data when accepting the process restart request from the device and the user identification data.

12. A seamless system comprising:
a managing unit which manages utilization state data obtained by associating user identification data accepted from a device, processing identification data indicating a process requested to be executed from the device, and state information on the process; and
an adding unit which embeds a command for notifying the state information on the device to one's own system in the contents provided to the device, wherein
when the state information has been accepted from the device, the managing unit registers the received information in the utilization state data, and when a restart request and the user identification data have been accepted, the managing unit restarts a process corresponding the user identification data based on the utilization state data.

13. A seamless system comprising:
a managing unit which manages utilization state data obtained by associating user identification data accepted from a device, processing identification data indicating a process requested to be executed from the device, and state information on the process;
a rewriting unit which, when address information on another process is included in contents provided to the device, rewrites the address information into address information including link information on one's own system based on the address information; and
an adding unit which embeds a command for notifying the state information on the device to one's own system in the contents provided to the device, wherein
the managing unit stores received information as the utilization data when receiving the processing identification data based on the address information rewritten by the rewriting unit, registers the state information in the utilization state data when the state information has been accepted from the device, carries out restarting of the processing identification data corresponding to the user identification data and a process from the device based on the utilization state data when accepting the process restart request from the device and the user identification data, and carries out restarting of a process corresponding to the user identification data based on the utilization state data.

14. A recording medium recording a program to cause a computer to function as:
means for managing utilization state data obtained by associating user identification data accepted from a device with processing identification data indicating a process requested to be executed from the device;
means for registering the utilization state data, restart achievement data to be used to achieve restarting of the process indicated by the processing identification data; and
means for, when a restart request and the user identification data have been accepted, acquiring the processing identification data and the restart achievement data corresponding to the user identification data based on the utilization state data, and providing to an originating device making the restart request an execution result of the process indicated by the processing identification data obtained based on the restart achievement data.

15. A recording medium recording a program to cause a computer to function as:
means for managing utilization state data obtained by associating user identification data accepted from a device with processing identification data indicating a process requested to be executed from the device; and
means for, when a restart request and the user identification data have been accepted, acquiring the processing identification data corresponding to the user identification data based on the utilization state data, and providing to an originating device making the restart request an execution result of the process indicated by the processing identification data.

16. A recording medium recording a program to cause a computer to function as:
means for managing utilization state data obtained by associating user identification data accepted from a device with processing identification data indicating a process requested to be executed from the device;
means for, when an interrupt event has occurred in the device, registering in the utilization state data, state data indicating that the process indicated by the processing identification data has been interrupted; and
means for, when a restart request and the user identification data have been accepted, acquiring processing identification data for restart indicating interruption by the state data in association with the user identification data from among the utilization state data, and providing to an originating device making the restart request an execution result of the process indicated by the processing identification data for restart.

17. A recording medium recording a program to cause a computer to function as:
means for registering user identification data accepted from a device in utilization state data;
means for registering restart achievement data to be used to achieve restarting of a predetermined process in the utilization state data in association with the user identification data; and
means for, when a restart request and the user identification data have been accepted, acquiring the restart achievement data in association with the user identification data based on the utilization state data, and providing to an originating device making the restart request an execution result of the process obtained based on the restart achievement data.

18. A computer readable recording medium having a program for operating a computer recorded therein, the program comprising:
means for managing utilization state data obtained by associating user identification data accepted from a device, processing identification data indicating a process requested to be executed from the device, and information indicating an execution request of a process from the device; and
rewriting means for, when address information on another process is included in contents provided to the device, rewriting the address information into address information including link information on one's own system based on the address information, wherein
the managing means stores received information as the utilization state data when receiving the information indicating an execution request of a process from the device based on the address information rewritten by the rewriting means, and restarting a process corresponding to the user identification data based on the utilization state data when accepting the process restart request from the device.

19. A computer readable recording medium having a program for operating a computer recorded therein, the program comprising:
managing means for managing utilization state data obtained by associating user identification data accepted from a device, processing identification data indicating a process requested to be executed from the device, and utilization state information on the process; and
adding means for embedding a command for notifying the utilization state information on the device to one's own system in the contents provided to the device, wherein
when the utilization state information has been accepted from the device, the managing means registers the information in the utilization state data, and when a restart request and the user identification data have been accepted, the managing means restarts a process corresponding the user identification data based on the utilization state data.

20. A computer readable recording medium having a program for operating a computer recorded therein, the program comprising:
managing means for managing utilization state data obtained by associating user identification data accepted from a device, processing identification data indicating a process requested to be executed from the device, and state information on the process;
rewriting means for, when address information on another process is included in contents provided to the device, rewriting the address information into address information including link information on one's own system based on the address information; and
adding means for embedding a command for notifying the state information on the device to one's own system in the contents provided to the device, wherein
the managing unit stores received information as the utilization data when receiving the processing identification data based on address information rewritten by the rewriting means, registers the information in the utilization state data when the state information has been accepted from the device, and carries out restarting of a process corresponding to the user identification data based on the utilization state data when accepting the process executing request from the device and the user identification data.

21. A computer system processing continuing method comprising:
managing utilization state data obtained by associating user identification data accepted from a device with processing identification data indicating a process requested to be executed from the device;
registering in the utilization state data, restart achievement data to be used to achieve restarting of the process indicated by the processing identification data; and
when a restart request and the user identification data have been accepted, acquiring the processing identification data and the restart achievement data corresponding to the user identification data based on the utilization state data, and providing to an originating device making the restart request an execution result of the process indicated by the processing identification data obtained based on the restart achievement data.

22. A computer system processing continuing method comprising:
managing utilization state data obtained by associating user identification data accepted from a device with processing identification data indicating a process requested to be executed from the device; and
when a restart request and the user identification data have been accepted, acquiring the processing identification data corresponding to the user identification data based on the utilization state data, and providing to an originating device making the restart request an execution result of a process indicated by the processing identification data.

23. A computer system processing continuing method comprising:
managing utilization state data obtained by associating user identification data accepted from a device with processing identification data indicating a process requested to be executed from the device;
when an interrupt event has occurred in the device, registering in the utilization state data, state data indicating that the process indicated by the processing identification data has been interrupted; and
when a restart request and the user identification data have been accepted, acquiring processing identification data for restart indicating interruption by the state data in association with the user identification data from among the utilization state data, and providing to an originating device making the restart request an execution result of the process indicated by the processing identification data for restart.

24. A computer system processing continuing method comprising:
registering user identification data accepted from a device in utilization state data;
registering restart achievement data to be used to achieve restarting of a predetermined process in the utilization state data in association with the user identification data; and
when a restart request and the user identification data have been accepted, acquiring the restart achievement data corresponding to the user identification data based on the utilization state data, and providing to an originating device making the restart request an execution result of the process obtained based on the restart achievement data.

25. A computer system processing continuing method comprising:
managing utilization state data obtained by association user identification data accepted from a device, processing identification data indicating a process requested to be executed from the device, and information indicating an execution request of a process from the device;
when address information on another process is included in contents provided to the device, rewriting the address information into address information including link information on one's own system based on the address information;
when receiving information indicating a request for executing a process from the device based on the rewritten address information, storing the received information the utilization state data; and
when accepting a request for restarting a process from the device, restarting the process based on the utilization state data.

26. A computer system processing continuing method comprising:
managing utilization state data obtained by associating user identification data accepted from a device, processing identification data indicating a process requested to be executed from the device, and utilization state information on the process;
embedding a command for notifying the utilization state information on the device to one's own system in contents provided to the device;
when the utilization state information has been accepted from the device, registering the accepted information in the utilization state data, and when a restart request and the user identification data have been accepted, restarting a process corresponding to the user identification data based on the utilization state data.

27. A computer system processing continuing method comprising:
managing utilization state data obtained by associating user identification data accepted from a device, processing identification data indicating a process requested to be executed from the device, and state information on the process;
when address information on another process is included in contents provided to the device, rewriting the address information into address information including link information on one's own system based on the address information, and embedding a command for notifying the state information on the device to one's own system in the contents provided to the device; and
when receiving the processing identification data based on rewritten address information, storing the received information as the utilization state data; when the state information has been accepted from the device, registering the accepted state information in the utilization state; and when a process restart request and the user identification data have been accepted from the device, restarting a process corresponding to the user identification data based on the utilization state data.
